(19) United States
(12) Patent Application Publication
(10) Pub. No.: US 2025/0263303 A1
(43) Pub. Date: Aug. 21, 2025

(54) Synthesis Of Mxene Suspensions With Improved Stability

(71) Applicant: DREXEL UNIVERSITY, Philadelphia, PA (US)

(72) Inventors: Tyler S. Mathis, Philadelphia, PA (US); Yury Gogotsi, Ivyland, PA (US); Kathleen Maleski, Mount Airy, MD (US)

(21) Appl. No.: 19/070,813

(22) Filed: Mar. 5, 2025

Related U.S. Application Data
(63) Continuation of application No. 17/759,289, filed on Jul. 22, 2022, now abandoned.
(60) Provisional application No. 62/965,208, filed on Jan. 24, 2020.

(51) Int. Cl. C01B 32/907; H01B 1/04

(52) U.S. Cl. CPC C01B 32/907; H01B 1/04; C01P 2002/72; C01P 2002/74; C01P 2002/82; C01P 2002/84; C01P 2002/85; C01P 2002/88; C01P 2004/03; C01P 2004/04; C01P 2004/24; C01P 2006/40

(57) ABSTRACT

Provided are enhanced MXene materials made from MAX-phase precursors that comprise an excess of metal A. The resultant enhanced MXenes exhibit improved stability over periods of days and months, particularly when stored in aqueous media.

### RELATED APPLICATIONS

This application is a continuation of U.S. patent application Ser. No. 17/759,289 (filed Jul. 22, 2022); which is the National Stage Application of International Patent Application No. PCT/US2021/014617 (filed Jan. 22, 2021); which claims priority to and the benefit of U.S. Patent Application No. 62/965,208, “Synthesis of MXene Suspensions with Improved Stability” (filed Jan. 24, 2020). All foregoing applications are incorporated herein by reference in their entireties for any and all purposes.

### GOVERNMENT RIGHTS

This invention was made with government support under DE-AC05-00OR22725 awarded by the Department of Energy. The government has certain rights in the invention.

### TECHNICAL FIELD

The present disclosure relates to enhanced-stability compositions comprising free standing two dimensional crystalline solids, and methods of making the same.

### BACKGROUND

The ability to exfoliate layered materials into two-dimensional (2D) nanosheets with properties that differ significantly from their bulk counterparts has resulted in numerous scientific advances in the last couple of decades that have shaped understanding of how the mechanical, optical, and electronic properties of materials can be modified to meet our technological needs. This of course began with the mechanical exfoliation of graphite, but has since expanded to the isolation of 2D nanosheets of numerous layered materials including hexagonal boron nitride (h-BN), various transition metal dichalcogenides (TMDs), and layered metal oxides and hydroxides, to touch on just a few examples. Liquid phase exfoliation techniques are currently the best options for producing large quantities of solution processable 2D materials that are compatible for use with existing industrial technologies. There is a long-felt need in the art for enhanced-stability 2D nanosheets and for related methods of fabricating such materials.

### SUMMARY

In one aspect, the present disclosure provides a composition having enhanced storage stability, comprising: a substantially two-dimensional array of crystal cells, each crystal cell having an empirical formula of Mₙ₊₁Xₙ, such that each X is positioned within an octahedral array of M, wherein M is at least one Group IIIB, IVB, VB, or VIB metal, wherein each X is C, N, or a combination thereof; n=1, 2, 3, or 4, wherein at least one of said surfaces of each layer has surface terminations comprising alkoxide, carboxylate, halide, hydroxide, hydride, oxide, sub-oxide, nitride, sub-nitride, sulfide, thiol, or a combination thereof, and wherein, following storage in degassed deionized water at 25 deg. C. for 4 months, (a) stored composition exhibits an essentially unchanged UV-vis spectra between 200 and 1000 nm as compared to comparable composition that has not been stored, (b) a film formed from stored composition exhibits a conductivity between about 10,000 and 15,000 S/cm, (c) stored composition exhibits an essentially unchanged XPS spectra from a survey scan of the 2p region of M, or any combination of (a), (b), and (c).

In another aspect, the present disclosure provides a device, the device comprising a composition according to the present disclosure.

Also provided are methods, the methods comprising fabricating a composition according to the present disclosure.

Further provided are methods of preparing a composition, comprising: removing substantially all of the A atoms from a MAX-phase composition having an empirical formula of Mₙ₊₁AXₙ and comprising an excess of A, M, and/or X, wherein M is at least one Group IIIB, IVB, VB, or VIB metal, wherein A is an A-group element, each X is C, N, or a combination thereof, and n=1, 2, 3, or 4; thereby providing a composition comprising at least one layer having a first and second surface, each layer comprising a substantially two-dimensional array of crystal cells, each crystal cell having an empirical formula of Mₙ₊₁Xₙ, such that each X is positioned within an octahedral array of M, and wherein at least one of said surfaces of each layer has surface terminations comprising alkoxide, carboxylate, halide, hydroxide, hydride, oxide, sub-oxide, nitride, sub-nitride, sulfide, thiol, or a combination thereof.

Additionally provided are methods, comprising: with a MAX-phase composition having an empirical formula of Mₙ₊₁AXₙ and comprising an amount of MA intermetallic impurities, the MAX-phase composition optionally being formed from thermal treatment of an about 2:1:1 mass ratio of MX, M, and A particulate, removing substantially all of the A atoms from the MAX-phase composition, and removing substantially all of the intermetallic impurities from the MAX-phase composition.

Further provided are methods, comprising: combining amounts of a metal M, a composition MX, and a metal A to form a mixture, the mixture (a) comprising an amount of the metal A that is in excess of the amount needed to make a stoichiometric amount of a MAX-phase material formed from M, MX, and A, (a) comprising an amount of the composition MX that is in excess of the amount needed to make a stoichiometric amount of a MAX-phase material formed from M, MX, and A, (c) comprising an amount of the metal M that is in excess of the amount needed to make a stoichiometric amount of a MAX-phase material formed from M, MX, and A, or any combination of (a), (b), and (c); treating the mixture so as to give rise to a MAX-phase material, optionally removing substantially all of the A atoms from the MAX-phase composition, and optionally removing substantially all of the intermetallic impurities from the MAX-phase composition.

Also provided are compositions having enhanced storage stability, comprising:
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof;
n=1, 2, 3, or 4,
wherein at least one of said surfaces of each layer has surface terminations comprising alkoxide, carboxylate, halide, hydroxide, hydride, oxide, sub-oxide, nitride, sub-nitride, sulfide, thiol, or a combination thereof, and
wherein, said composition is formed from removing essentially all of metal A from a MAX-phase material comprising metal M, element X, and an excess of metal A.

Further provided are compositions having enhanced storage stability, comprising:
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof;
n=1, 2, 3, or 4, and
wherein at least one of said surfaces of each layer has surface terminations comprising alkoxide, carboxylate, halide, hydroxide, hydride, oxide, sub-oxide, nitride, sub-nitride, sulfide, thiol, or a combination thereof, and
wherein the composition has a molar ratio of M:X in the range of from (n+1):0.95n to n+1:1.05n.

Further provided are compositions having enhanced storage stability, comprising:
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof;
n=1, 2, 3, or 4, and
wherein at least one of said surfaces of each layer has surface terminations comprising alkoxide, carboxylate, halide, hydroxide, hydride, oxide, sub-oxide, nitride, sub-nitride, sulfide, thiol, or a combination thereof, and
(a) wherein the composition exhibits an essentially an essentially unchanged UV-Vis spectrum between 200 and 1000 nm after storage in water at room temperature for 30 days,
(b) wherein the composition exhibits an essentially an essentially absorbance at a given wavelength between 200 and 1000 nm after storage in water at room temperature for 30 days,
(c) wherein the composition exhibits an essentially an essentially unchanged Raman spectrum between 200 and 1000 nm after storage in water at room temperature for 30 days,
(d) wherein the composition comprises a plurality of flakes and wherein after storage in water at room temperature for 300 days, (1) the flakes are essentially crack-free, (2) the flakes are essentially free of metal oxide crystals formed of M, or both (1) and (2), or
(e) any combination of (a), (b), (c), and (d).

The disclosed technology is, in some instances, illustrated herein with Ti₃AlC₂ and Ti₃C₂ materials. These materials are exemplary only, and it should be understood that the present disclosure is not limited to such materials.

In some illustrations in this disclosure, we modified the synthesis of the MAX phase Ti₃AlC₂ to include excess A-element (Al) to produce less defective Ti₃AlC₂ grains for the production of solutions of high quality Ti₃C₂ nanosheets. The use of additional A-element in the synthesis of MAX phases introduces impurity phases into the final sintered product which detract from the attractive properties of the MAX phases.

Aqueous Ti₃C₂ solutions produced from the 2.2-Ti₃AlC₂ MAX had exceptional shelf life (>6 months) with only minimal steps taken to protect the MXene. Free standing films made from the fresh Ti₃C₂ solutions had electronic conductivities ranging from 10,000 to 20,000 S/cm, and films made from Ti₃C₂ suspensions that were stored in ambient conditions for 4 and 6 months had conductivities of over 10,000 and 6,000 S/cm, respectively. The results presented here provide a way to improve the oxidative stability of MXenes.

### BRIEF DESCRIPTION OF THE DRAWINGS

The following figures are presented as illustrative examples, and should not be considered to limit the scope of the invention in any way. Except where otherwise noted, the scales of the figures may be exaggerated for illustrative purposes.

FIGS. 1a-1d. (FIG. 1a) XRD patterns of 2.2-Ti₃AlC₂ before (black) and after (red) HCl washing. (FIG. 1b) SEM image of a hexagonal grain of H—Ti₃AlC₂. (FIG. 1c) SEM image of a large single flake of Ti₃C₂ produced via HF/HCl etching and LiCl delamination. (FIG. 1d) Electronic conductivity of freestanding vacuum filtered Ti₃C₂ films from different stages of the delamination process

FIGS. 2a-2d. (FIG. 2a) UV-vis spectra recorded over time for an aqueous Ti₃C₂ solution stored in ambient conditions. (FIG. 2b) Absorbance change over time for the stored Ti₃C₂ solution from the UV-vis spectra in (FIG. 2a). (FIG. 2c) Electronic conductivity of free standing Ti₃C₂ films made from solutions stored for different periods of time. (FIG. 2d) Raman spectra of the films made from solutions stored for different periods of time

FIGS. 3a-3b. (FIG. 3a) Ti 2p survey scan from the XPS spectra of H—Ti₃AlC₂. (FIG. 3b) Ti 2p survey scan from the XPS spectra of standard Ti₃AlC₂.

FIGS. 4a-4c. (FIG. 4a) Photographs of blocks of sintered Ti₃AlC₂ with 1 molar equivalent of aluminum (top) and 2.2 molar equivalents of aluminum (bottom). (FIG. 4b) Recorded mass loss for different trials of acid washing the 2.2-Ti₃AlC₂ MAX. (FIG. 4c) Photograph of the bright purple filtrate produced during the acid washing of 2.2-Ti₃AlC₂ using hydrochloric acid.

FIGS. 5a-5d. Scanning electron microscope images of 2.2-Ti₃AlC₂ MAX washed with different acids. (FIG. 5a) 2.2-Ti₃AlC₂ washed using 9M HCl. (FIG. 5b) 2.2-Ti₃AlC₂ washed using 10 wt. % HNO₃. (FIG. 5c) Higher magnification image of the 2.2-Ti₃AlC₂ particle in (FIG. 5a) where no alumina can be seen on the particle's surface. (FIG. 5d) Higher magnification image of the 2.2-Ti₃AlC₂ particle in (FIG. 5b) where a significant amount of alumina can be seen on the particle's surface.

FIG. 6. Scanning electron microscope images of various H—Ti₃AlC₂ particles showing the hexagonal nature of the MAX particles produced using excess A-element during the sintering process.

FIG. 7 provides concentrations of Ti₃C₂ solutions as a function of the total amount of water (or wash cycles) used during the delamination process. The black line is for H—Ti₃AlC₂ and the red line is for 2.2-Ti₃AlC₂ that has not been washed using HCl to remove intermetallic impurities.

FIGS. 8a-8e. Scanning electron microscope images of Ti₃C₂ flakes from different wash steps during the delamination process. (FIG. 8a) 2^{nd} wash, a significant quantity of LiCl can be seen mixed with the flakes, (FIG. 8b) 3rd wash, (FIG. 8c) 4th wash, (FIG. 8d) 5th wash, and (FIG. 8e) 6th wash.

FIGS. 9a-9c. UV-vis data for Ti₃C₂ solutions produced from acid washed 2.2-Ti₃AlC₂ (FIG. 9a), non-acid washed (FIG. 9b) 2.2-Ti₃AlC₂, and (FIG. 9c) a comparison of the stability of Wash 4 samples from acid washed and non-acid washed 2.2-Ti₃AlC₂ over a two-week period. Removing the intermetallic impurities via acid washing resulted in more consistent UV-vis spectra and improved stability.

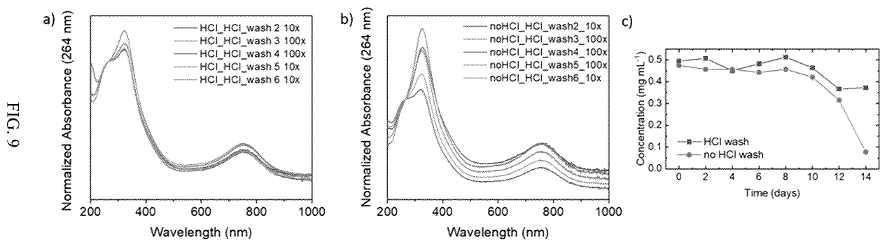

FIGS. 10a-10d. X-ray photoelectron spectroscopy data for H—Ti₃AlC₂ MAX measured at two different spots on the same sample. Spectra from Spot 1 are red and spectra from Spot 2 are green. (FIG. 10a) Ti 2p region, (FIG. 10b) C 1s region, (FIG. 10c) Al 2p region, and (FIG. 10d) O 1s region. The overlapping spectra for Spot 1 and Spot 2 indicate the uniformity of the composition of the H—Ti₃AlC₂ MAX.

FIGS. 11a-11d. X-ray photoelectron spectroscopy data for standard Ti₃AlC₂ MAX produced with one molar equivalent of aluminum measured at two different spots on the same sample. Spectra from Spot 1 are red and spectra from Spot 2 are green. (FIG. 11a) Ti 2p region, (FIG. 11b) C 1s region, (FIG. 11c) Al 2p region, and (FIG. 11d) O 1s region. The spectra for Spot 1 and Spot 2 do not match, which indicates that the composition of the standard Ti₃AlC₂ MAX is non-uniform.

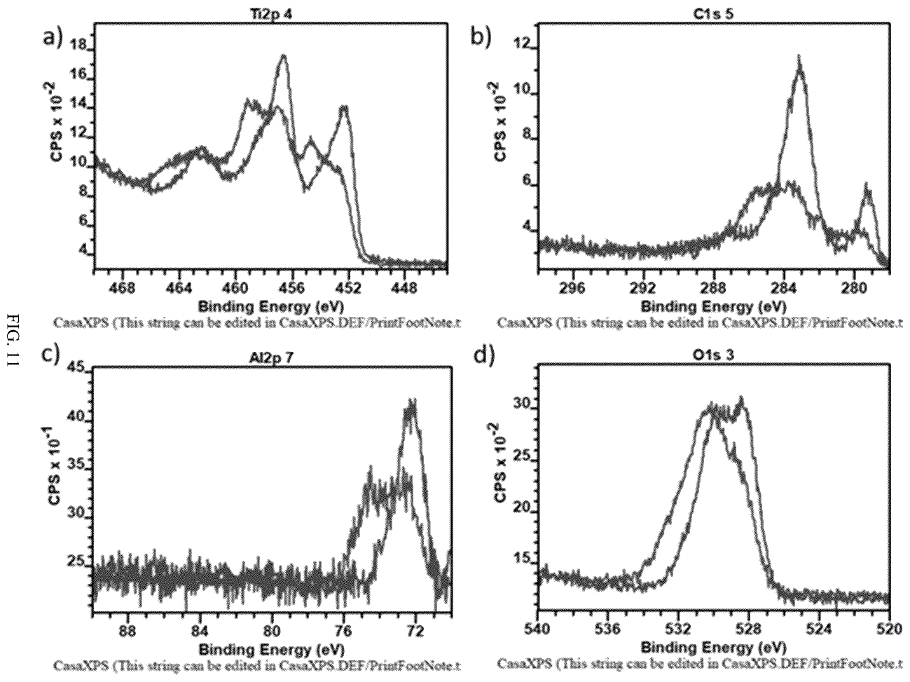

FIGS. 12a-12e provide (FIG. 12a) X-ray diffraction (XRD) patterns of Al—Ti₃AlC₂ before (red) and after (blue) HCl washing. (FIG. 12b) Polarized Raman spectra of Al—Ti₃AlC₂ (red, not acid washed) and conventional Ti₃AlC₂ (green). (FIG. 12c) Scanning electron microscopy (SEM) image of a hexagonal grain of HCl washed Al—Ti₃AlC₂. (FIG. 12d) SEM image of a hexagonal, single layer flake of Al—Ti₃C₂ produced via HF/HCl etching and LiCl delamination (supported on an anodic aluminum oxide membrane). (FIG. 12e) High-angle annular dark-field scanning transmission electron (STEM) microscopy images of Ti₃C₂ flake edges produced from conventional Ti₃AlC₂ (top) and Al—Ti₃AlC₂ (bottom). Both types of MAX were HCl washed prior to etching. Inset in (FIG. 12e) shows an atomic-resolution cross-sectional TEM image from an Al—Ti₃C₂ flake.

FIGS. 13a-13b provide (FIG. 13a) Electronic conductivity of freestanding films produced by vacuum-assisted filtration of Al—Ti₃C₂ suspensions at different stages of the delamination process. Black squares represent measurements performed on different samples. Blue circles represent average values, where appropriate. (FIG. 13b) Thermogravimetric analysis (TGA) in air for delaminated ((d), top) and multilayer ((ML), bottom) Ti₃C₂ produced from Al—Ti₃AlC₂ and conventional Ti₃AlC₂. Both types of MAX were washed using HCl prior to etching.

FIGS. 14a-14f provide (FIG. 14a) Absorbance changes over time (relative to the initial absorbance at 264 nm) for the stored Al—Ti₃C₂ solution calculated from the UV-vis spectra in (FIG. 14b). The grey region corresponds to suspension concentrations of 1.5-1.8 mg/mL. (FIG. 14b) UV-vis spectra recorded over time for an aqueous Al—Ti₃C₂ solution stored in ambient conditions. (FIG. 14c) Electronic conductivity of freestanding Al—Ti₃C₂ films made from solutions stored for different periods of time. (FIG. 14d) Raman spectra of films made from solutions stored for different periods of time. TEM images of a fresh Al—Ti₃C₂ flake (FIG. 14e) and an Al—Ti₃C₂ flake from a ten-month-old solution (FIG. 14f). The red circles mark all the observable pinholes in the flake.

FIGS. 15a-15c provide X-ray photoelectron spectroscopy (XPS) spectra of (FIG. 15a) Ti 2p, (FIG. 15b) C 1s, and (FIG. 15c) Al 2p regions of Al—Ti₃AlC₂ (left) and conventional Ti₃AlC₂ (right). Both the Al—Ti₃AlC₂ and conventional Ti₃AlC₂ were acid washed using HCl prior to performing XPS measurements for consistency.

FIGS. 16a-16d provide FIG. (FIG. 16a) blocks of Ti₃AlC₂ (top) and Al—Ti₃AlC₂ (bottom (FIG. 16b) image of the purple filtrate from the acid washing process, (FIG. 16c) Al—Ti₃AlC₂ particles after acid washing using HCl, (FIG. 16d) higher magnification of (FIG. 16c).

FIG. 17 provides XRD patterns of conventional Ti₃AlC₂ before (black, lower line) and after (red, upper line) acid washing.

FIG. 18 provides SEM images of different hexagonal Al—Ti₃AlC₂ particles after HCl washing.

FIGS. 19a-19d provides Low magnification SEM images of conventional Ti₃AlC₂ (FIG. 19a, FIG. 19b) and Al—Ti₃AlC₂ (FIG. 19c, FIG. 19d) particles.

FIGS. 20a-20b provide HRSTEM images of basal planes of (FIG. 20a) Ti₃C₂ and (FIG. 20b) Al—Ti₃C₂.

FIGS. 21a-21c provide (FIG. 21a) Concentration vs. delamination cycle for HCl washed and non HCl washed Al—Ti₃C₂ suspensions, (FIG. 21b) Al—Ti₃C₂ flake size distributions for different delamination cycles, (FIG. 21c) SEM image of a large single layer Al—Ti₃C₂ flake.

FIG. 22 provides TEM images of Al—Ti₃C₂ flakes that were stored as an aqueous suspension for 10 months. Note that there are remarkably few pinholes and TiO₂ crystals (black spots).

FIG. 23 provides XPS spectra of the O 1s region of Al—Ti₃AlC₂ (left) and conventional Ti₃AlC₂ (right). Both the Al—Ti₃AlC₂ and conventional Ti₃AlC₂ were acid washed using HCl prior to performing.

FIG. 24 provides XRD patterns of the precursor powder mixtures for conventional Ti₃AlC₂ (black, lower line) and Al—Ti₃AlC₂ (red, upper line) collected after ball milling.

FIGS. 25a-25c provide UV-vis spectra for different delamination cycles of Al—Ti₃C₂ suspensions synthesized using (FIG. 25a) non HCl washed Al—Ti₃AlC₂ and (FIG. 25b) HCl washed Al—Ti₃AlC. (FIG. 25c) Stability of Al—Ti₃C₂ suspensions over time made from non HCl washed Al—Ti₃AlC₂ and HCl washed Al—Ti₃AlC.

FIG. 26 provides mass lost during the washing of Al—Ti₃AlC₂ with 9 M HCl.

FIG. 27 provides the molar composition of conventional Ti₃AlC₂ (green) and Al—Ti₃AlC₂ (blue) measured via XPS. We obtained the stoichiometric ratios by taking into account all of the components in the Ti 2p and Al 2p core level regions, and only the component for C—Ti in the C 1s core level region. We obtained the oxygen stoichiometric ratio by first calculating the oxygen attributed to adventitious carbon and then attributed the remaining oxygen to the MAX samples.

FIGS. 28a-28c provides TEM images of (FIG. 28a) MXene flakes from fresh d-Ti₃C₂-Tₓ solution and from (FIG. 28b) aged solutions stored in air at room temperature for 7 days. FIG. 28c provides TEM images of d-Ti₃C₂-Tₓ flakes aged in Ar under refrigeration for 30 days. As shown, titania crystals appear in the 7 day and the 30 day samples, as well as broken flakes appearing in the 30 day sample.

FIG. 29 provides TEM images of fresh Al—Ti₃C₂ flakes (top) and Al—Ti₃C₂ flakes aged in Ar at room temperature for 10 months. As shown, there are no titania crystals and no cracks in the flakes.

FIGS. 30a-30b provide (FIG. 30a) Raman spectra of freshly made Ti₃C₂Tₓ films from water and isopropanol based solutions; and (FIG. 30b) freshly made Ti₃C₂Tₓ films from water/O₂, water/Ar, iso-propanol/O₂, and iso-propanol/Ar solutions after 1 month of aging. As shown, after one month of aging, the spectra lose the peaks characteristic of the Ti₃C₂ MXene.

FIG. 31 provides Raman spectra of Al—Ti₃C₂ films made from water-based Al—Ti₃C₂ solutions that were stored for different lengths of time. (Fresh=bottom line, 4 months of aging=middle line; 6 months of aging=top line). As shown, the spectra remain unchanged as to their characteristic MXene peaks.

FIGS. 32a-32c provide UV-Vis spectra for MXene samples. FIG. 32a provides normalized UV-Vis spectra of a Ti₃C₂ solution aged in Ar at (FIG. 32a) room temperature and (FIG. 32b) under refrigeration. As shown, the spectral shapes change over time, showing that the materials are degrading. FIG. 32c provides the stability of colloidal d-Ti₃C₂-Tx in different environments (under Ar at low temperature and room temperature and air at low temperature and room temperature), with the decrease in intensity over time indicating material degradation.

FIG. 33 provides the stability of Ti₃C₂Tₓ colloidal solutions over time, with the decrease in intensity showing degradation.

FIG. 34 shows that the spectra for Al—Ti₃C₂ does not change shape over time, and the intensity does not linearly decrease.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

### MXenes

Since the discovery of 2D titanium carbide (Ti₃C₂T_{z}) MXene, additional MXenes have been discovered so far and more are being routinely discovered. Owing to their chemical diversity, hydrophilicity, 2D morphology and metallic conductivity MXenes have shown promise in various applications like energy storage, catalysts for hydrogen evolution reactions, gas sensing, water desalination, reinforcement in polymer composites, EMI shielding, and many more.

MXenes have a general formula Mₙ₊₁XₙT_{z} and are so called because they are derived by etching the A atomic layers from the parent MAX (Mₙ₊₁AXₙ) phase, where M stands for an early transition metal, A can be (generally) a group 13 or 14 element, and X stands for C and/or N. The -ene suffix was added to make the connection to other 2D materials, like graphene, silicence, etc. The T_{z} in the chemical formula stands for the various —O, —OH, —F surface terminations that replace the Al layers upon etching.

MAX phase compositions are generally recognized as comprising layered, hexagonal carbides and nitrides have the general formula: Mₙ₊₁AXₙ, (MAX) where n=1 to 4, in which M is typically described as an early transition metal (comprising a Group IIIB, IVB, VB, or VIB metal, or Mn), A is described as an A-group (mostly IIIA and IVA, or groups 13 and 14) element and X is either carbon and/or nitrogen. See, e.g., M. W. Barsoum, et al., “Synthesis and Characterization of a Remarkable Ceramic: Ti₃SiC₂,” J. Amer. Ceramics. Soc., 79, 1953-1956 (1996); M. W. Barsoum, “The M_{N+1}AX_{N} Phases: A New Class of Solids: Thermodynamically Stable Nanolaminates,” Progress in Solid State Chemistry, 28, 201-281 (2000), both of which are incorporated by reference herein. While Ti₃AlC₂ is among the most widely studied of these materials, more than 60 MAX phases are currently known to exist and are useful in the present invention. While not intending to be limiting, representative examples of MAX phase materials useful in the present invention include: (211) Ti₂CdC, Sc₂InC, Ti₂AlC, Ti₂GaC, Ti₂InC, Ti₂TlC, V₂AlC, V₂GaC, Cr₂GaC, Ti₂AlN, Ti₂GaN, Ti₂InN, V₂GaN, Cr₂GaN, Ti₂GeC, Ti₂SnC, Ti₂PbC, V₂GeC, Cr₂AlC, Cr₂GeC, V₂PC, V₂AsC, Ti₂SC, Zr₂InC, Zr₂TlC, Nb₂AlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂AlC, Ta₂GaC, Hf₂SnC, Hf₂PbC, Hf₂SnN, Hf₂SC; (312) Ti₃AlC₂, V₃AlC₂, Ti₃SiC₂, Ti₃GeC₂, Ti₃SnC₂, Ta₃AlC₂, and (413) Ti₄AlN₃, V₄AlC₃, Ti₄GaC₃, Ti₄SiC₃, Ti₄GeC₃, Nb₄AlC₃, and Ta₄AlC₃. Solid solutions of these materials can also be used as described herein (e.g., see Example 4).

Although the instant disclosure describes the use of Ti₃C₂-type MXene because of the convenient ability to prepare larger scale quantities of this material, other MXene compositions are within the scope of this disclosure, e.g., MXene compositions of any of U.S. patent application Ser. No. 14/094,966 (filed Dec. 3, 2013); 62/055,155 (filed Sep. 25, 2014); 62/214,380 (filed Sep. 4, 2015); 62/149,890 (filed Apr. 20, 2015); 62/127,907 (filed Mar. 4, 2015); or International Applications PCT/US2012/043273 (filed Jun. 20, 2012); PCT/US2013/072733 (filed Dec. 3, 2013); PCT/US2015/051588 (filed Sep. 23, 2015); PCT/US2016/020216 (filed Mar. 1, 2016);

PCT/US2016/028,354 (filed Apr. 20, 2016), PCT/US2020/054912 (filed Oct. 9, 2020), preferably where the MXene composition comprises titanium and carbon (e.g., Ti₃C₂, Ti₂C, Mo₂TiC₂, etc.). Each of the foregoing is incorporated herein by reference in its entirety for any and all purposes.

### Results

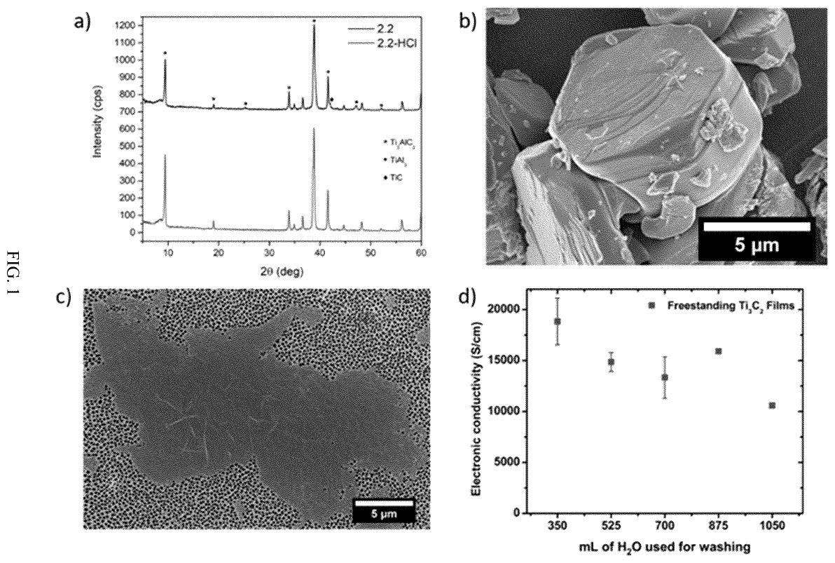

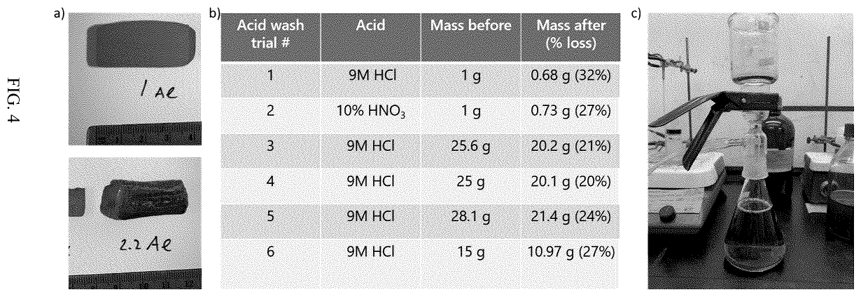

Following sintering of the precursor powders containing excess aluminum, the resulting block of 2.2-Ti₃AlC₂ MAX phase contains intermetallic impurities, namely in the form of TiAl₃, as seen in the X-ray diffraction (XRD) patterns of the as produced MAX (FIG. 1a). The intermetallic impurities cause the body of the block of MAX to have a lustrous, metallic sheen when the sintered block is milled, which is not the case for blocks of Ti₃AlC₂ produced using the typical synthesis recipes found in the literature (FIG. 4a). The intermetallic impurities can be removed simply by washing the milled 2.2-Ti₃AlC₂ powder in 9M HCl at room temperature.

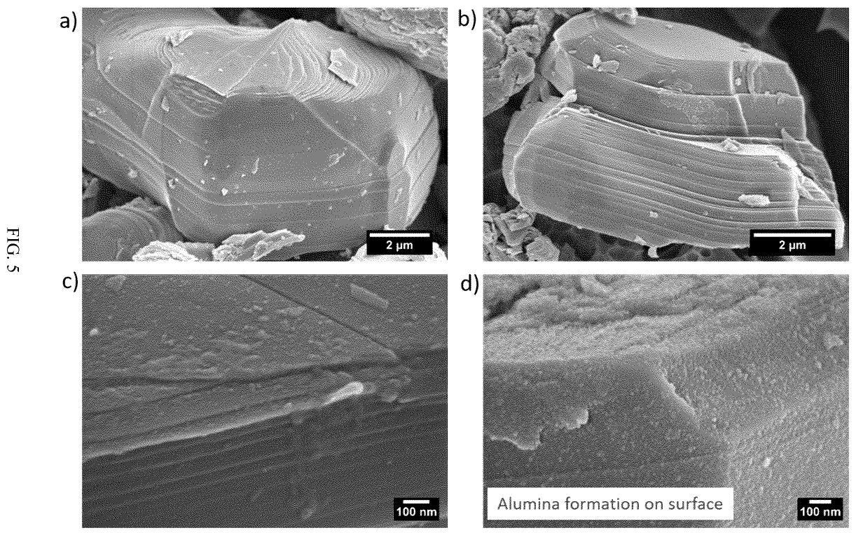

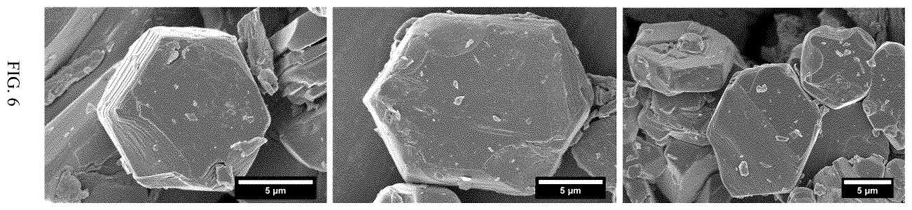

During neutralization of the acid washed Ti₃AlC₂ (referred to as H—Ti₃AlC₂) the acidic supernatant is a deep purple color (FIG. 4b), typical of solutions containing dissolved titanium. After the neutralized H—Ti₃AlC₂ powders are dried the XRD patterns show there are no remaining intermetallic impurities (FIG. 1a). Attempts at washing the Ti₃AlC₂ using 10 wt. % HNO₃ resulted in the formation of alumina on the surface of the MAX particles, which was not observed for the Ti₃AlC₂ washed using HCl (FIG. 5). Acid washing using nitric acid was not pursued further due to the nitric acid causing the formation of alumina on the surface of the MAX particles. In all cases, acid washing the 2.2-Ti₃AlC₂ MAX resulted in ca. 20-30% loss in mass which we attribute to the removal of the intermetallic impurities. The H—Ti₃AlC₂ MAX powder has well formed, hexagonal grains which we believe to be due to enhanced diffusion of reactants in the sintering process caused by the presence of the excess A-element (FIG. 1b and FIG. 6a-c).

Etching the H—Ti₃AlC₂ MAX using a mixture of hydrofluoric and hydrochloric acids (HF/HCl etching) and then delaminating the resulting Ti₃C₂ by stirring the etched Ti₃C₂ in an aqueous solution of LiCl results in the production of high-yield, single flake Ti₃C₂ suspensions (FIG. 6).

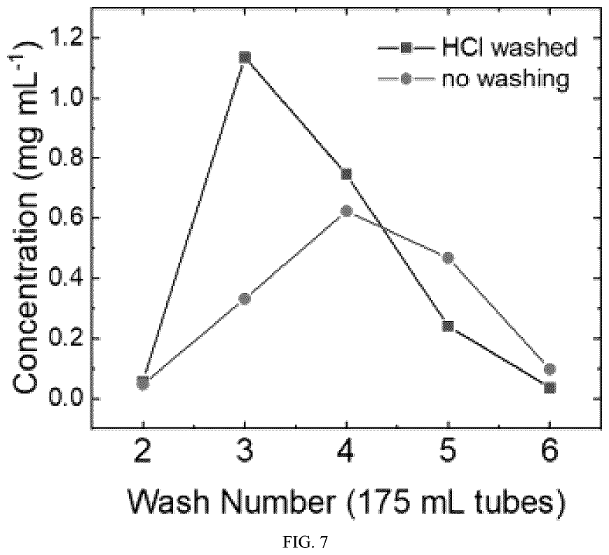

The quantity and concentration of the single flake Ti₃C₂ solutions produced during each cycle of the delamination process is dependent on the quantity of MAX that was etched and the size of the centrifuge tubes used during delamination (FIG. 7). The numbers reported for the solution concentrations and yield in this study are typical for etching 1 g of H—Ti₃AlC₂ in 20 mL of etchant and using 175 mL centrifuge tubes for delamination. Large single layer Ti₃C₂ flakes (>25 μm in the largest dimension, FIG. 1c) can be readily obtained using this method, but it must be noted that the flake sizes of the Ti₃C₂ flakes produced using this method are polydisperse, if a narrow range of flake size distribution is desired then density gradient centrifugation can be used to isolate flakes of the desired size.

One of the most notable properties of MXenes, and Ti₃C₂ in particular, is the high electronic conductivity of films produced from solutions of single layer MXene flakes. Freestanding films made by vacuum filtering the Ti₃C₂ solutions produced by etching the H—Ti₃AlC₂ using the HF/HCl etchant have conductivities ranging from slightly higher than 10,000 S/cm up to values exceeding 20,000 S/cm (FIG. 1d). These conductivity values are notably higher than values reported in recent years for Ti₃C₂ freestanding films and thin film coatings, which are between 5,000 and 10,000 S/cm.

The conductivity of the Ti₃C₂ films is slightly dependent on the quantity of water used to wash the Ti₃C₂ during the delamination process. Without being bound to any particular theory, because the concentration of the delaminated Ti₃C₂ solutions is also dependent on the wash cycle it is likely that the highest quality flakes are delaminating first leading to the highest quality films. However, in the initial stages of washing there will still be LiCl present in the delaminated solution which may also influence the properties of the final films, but as washing continues the LiCl can be removed (FIG. 7).

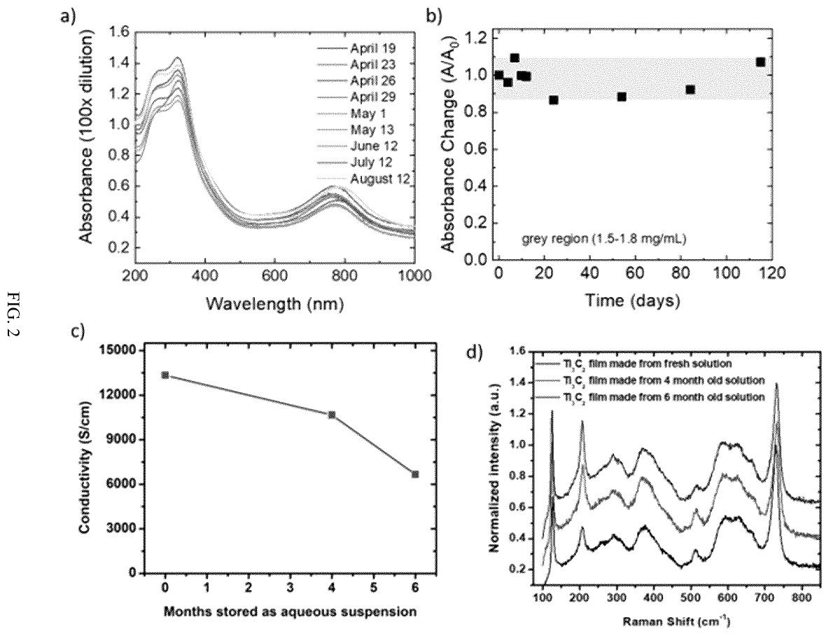

The most notable property of the Ti₃C₂ solutions produced from the H—Ti₃AlC₂ MAX is the remarkable shelf life of the solutions. To test the shelf of the Ti₃C₂ solutions we took the minimum amount of precautions to protect the Ti₃C₂ flakes to simulate the most typical laboratory storage conditions. The delaminated Ti₃C₂ solution was degassed by bubbling argon through the solution at the as produced concentration directly after centrifugation before being transferred to a sealed argon filled vial and then stored away from light in a laboratory bench drawer at room temperature. UV-vis measurements recorded periodically during storage show how there are no noticeable changes in the stored sample's spectra up until the 4-month mark (FIG. 2a), where a slight red-shift in the ˜780 peak occurs, which is an indication that oxidation is beginning to occur.

However, when a film was made from the solution that was stored for 4 months the conductivity of the resulting film was still over 10,000 S/cm, well within the range of films made directly after delamination, and the film was as flexible and lustrous as would be expected for a film made with fresh Ti₃C₂ (FIG. 2c).

After 6 months of storage the UV-vis spectra of the Ti₃C₂ solution still has only a slight red-shift in the ˜780 nm peak, but the conductivity of the film made from the 6 month old solution dropped to just over 6000 S/cm. Films made from the 6 month old solution are still highly flexible, but they are slightly darker in color.

Raman spectra of the Ti₃C₂ films made from the fresh, 4 month old, and 6 month old solutions are identical and give no indication that serious oxidation has occurred during storage (FIG. 2d), but some degradation does begin after approximately 4 months for these storage conditions, as seen in the decreases in electronic conductivity.

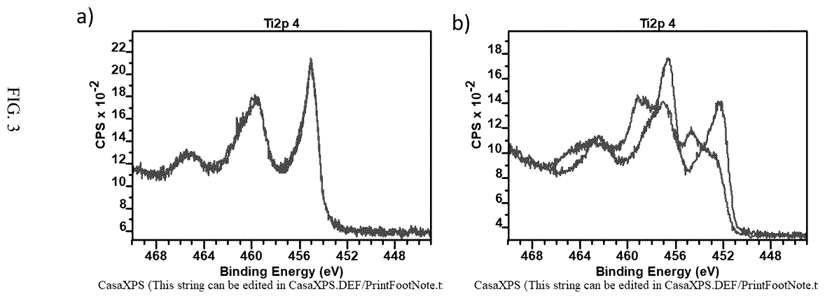

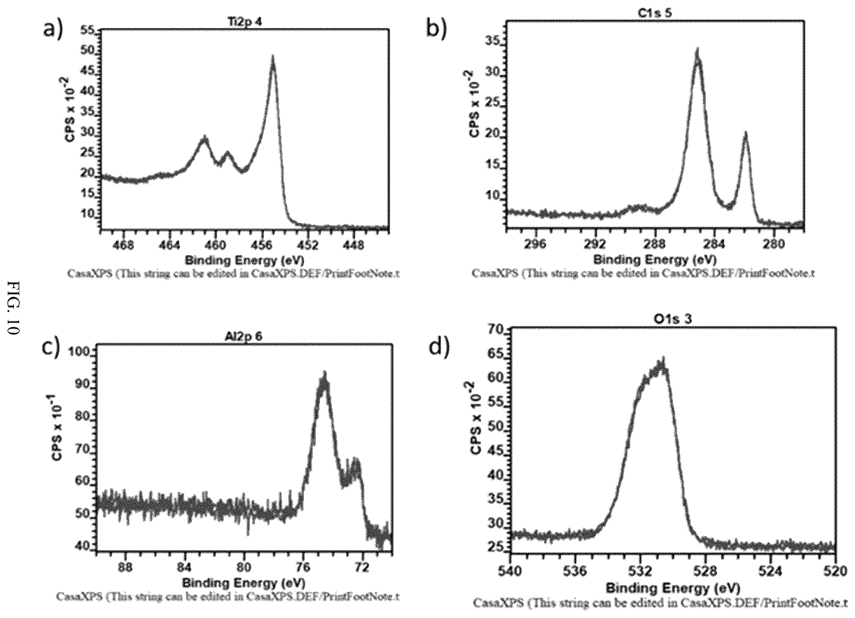

The excess A-element used during the synthesis of the H—Ti₃AlC₂ MAX phase resulted in material with a more uniform composition, as can be seen from the XPS spectra for the Ti 2p region of the H—Ti₃AlC₂ MAX (FIG. 3a). For comparison, the XPS spectra for Ti₃AlC₂ synthesized using the standard amount of A-element reported in the literature have more heterogeneity (FIG. 3b). The uniformity in the XPS spectra for H—Ti₃AlC₂ is consistent across the C 1s, Al 2p, and O 1s regions (FIG. 10), whereas the non-uniformity of the XPS spectra of the standard Ti₃AlC₂ is also consistent for the same regions.

By modifying the synthesis of the parent Ti₃AlC₂ MAX phase to produce a precursor material of higher quality, one can improve the quality of the Ti₃C₂ flakes, thereby improving the shelf life and stability of the MXene.

### Experimental

The following experimental results are illustrative only and do not limit the scope of the present disclosure or of the appended claims.

### Ti₃AlC₂ MAX Synthesis

A 2:1:1 (mass ratio) mix of TiC, Ti, and Al powders was ball milled using zirconia milling media for 18 h at 70 rpm. 2:1 mass ratio of zirconia balls to precursor powder. The ball milled precursor powders are packed into an alumina crucible and covered with graphite foil before being placed in a tube furnace. After the crucible is placed in the furnace, the tube is purged with argon for 30 min at room temperature. After purging, the precursor powders are sintered at 1380° C. for 2 h with constant flowing argon. The heating and cooling rate are both 3° C./min. The argon flow rate is ˜100 sccm. The sintered block of Ti₃AlC₂ is then milled using a TiN coated milling bit. The milled MAX powder is then washed using 9M HCl. Typically, 500 mL of 9M HCl is sufficient to wash upwards of 50 to 60 g of Ti₃AlC₂. The MAX can be washed until the evolution of gas bubbles from the solution stops, 2 h is an exemplary washing duration.

The washed MAX is then neutralized by filtering the Ti₃AlC₂/HCl mixture though a vacuum filtration unit followed by repeated filtering of DI water through the Ti₃AlC₂ cake. The neutralized MAX is then dried in a vacuum oven for at least 6 h. The pore size of the filter membrane is 5 μm.

The dried Ti₃AlC₂ is then sieved through a 450-mesh particle sieve. The washed, dried, and sieved Ti₃AlC₂ is then ready for etching

### Ti₃C₂ MXene Synthesis

Typically, 1 g of Ti₃AlC₂ is mixed with 20 mL of etchant and stirred at 400 rpm for 24 h at 35° C. The etchant is a 6:3:1 mixture (by volume) of 12 M HCl, DI water, and 50 wt. % HF. For 1 g MAX/20 mL of etchant, a 60 mL HDPE bottle will typically be used as the etching container. The etched Ti₃C₂ is washed DI water via repeated centrifugation and decantation until the supernatant reaches pH ˜6 using a 175 mL centrifuge tube. Once the MXene is neutralized, one more additional wash cycle will be performed to ensure the washing process is complete. 5 wash cycles using a single 175 mL centrifuge tube are typically enough for 1 g of MAX etched using 20 mL of etchant.

The etched Ti₃C₂ multilayer sediment is then dispersed in a 0.5 M solution of LiCl (typically 50 mL solution/gram of MXene) to start the delamination process. The MXene/LiCl suspension is then stirred at 400 rpm for a minimum of 4 h at room temperature.

The MXene/LiCl suspension is then washed with DI water via repeated centrifugation and decantation of the supernatant using a 175 mL centrifuge tube. The first wash cycle always sediments completely after 3 to 5 minutes of centrifugation at 3500 rpm. The 2nd wash and onwards are centrifuged for 1 h at 3500 rpm before the Ti₃C₂ supernatants are collected to ensure the MXene solutions are single flake.

### Physical Characterization

Conductivity measurements were performed using a four-point probe with X mm separation (Jandel) on free standing Ti₃C₂ films made by vacuum filtering delaminated single flake Ti₃C₂ solutions. The measured sheet resistance of the Ti₃C₂ films was converted into conductivity by using the thickness of the films taken from SEM images of the film cross sections. UV-vis spectra were recorded using a X spectrometer, where the absorbance was measured for samples at 100× dilution.

For the long-term storage tests solutions from the 4th wash (700 mL) were used since the excess LiCl would have been removed by that cycle. The concentrations of the stored Ti₃C₂ samples were calculated by measuring the absorbance changes of the samples over time versus the absorbance of the Ti₃C₂ samples at the initial time of storage. Raman spectra were recorded using a Renishaw in Via spectrometer.

### Additional Disclosure and Results

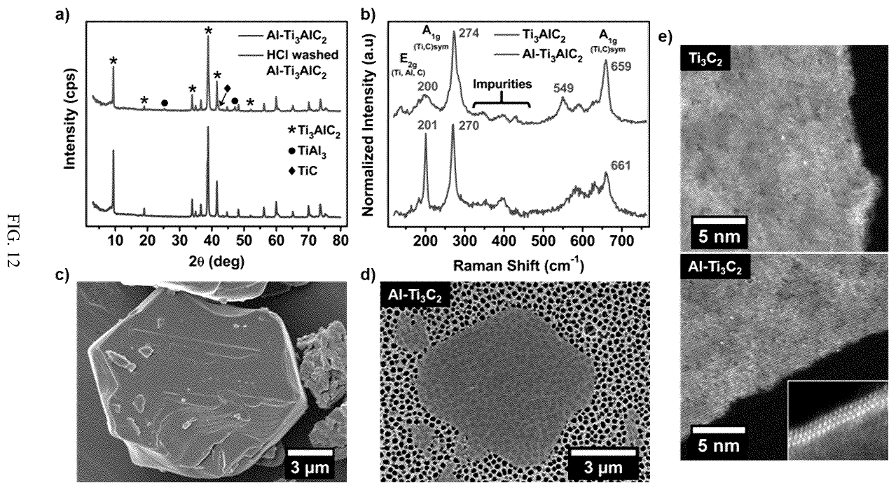

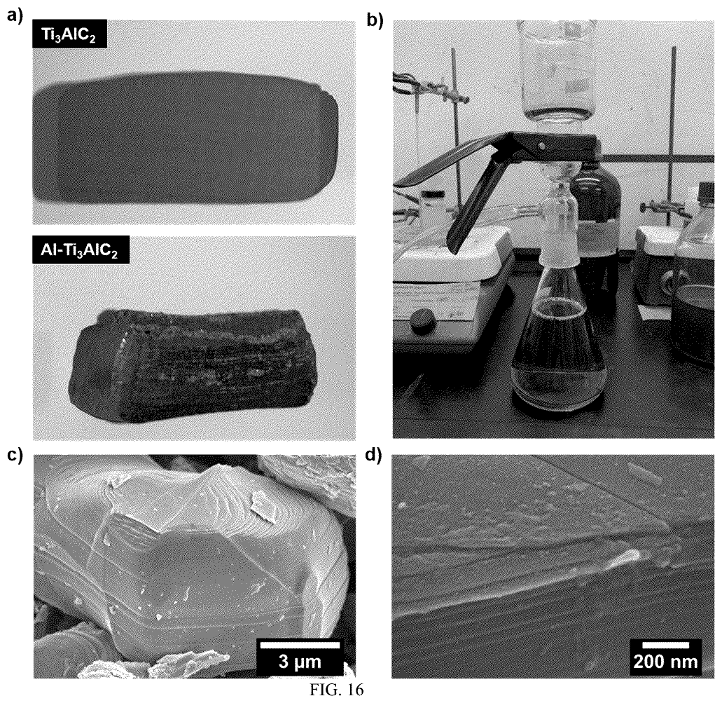

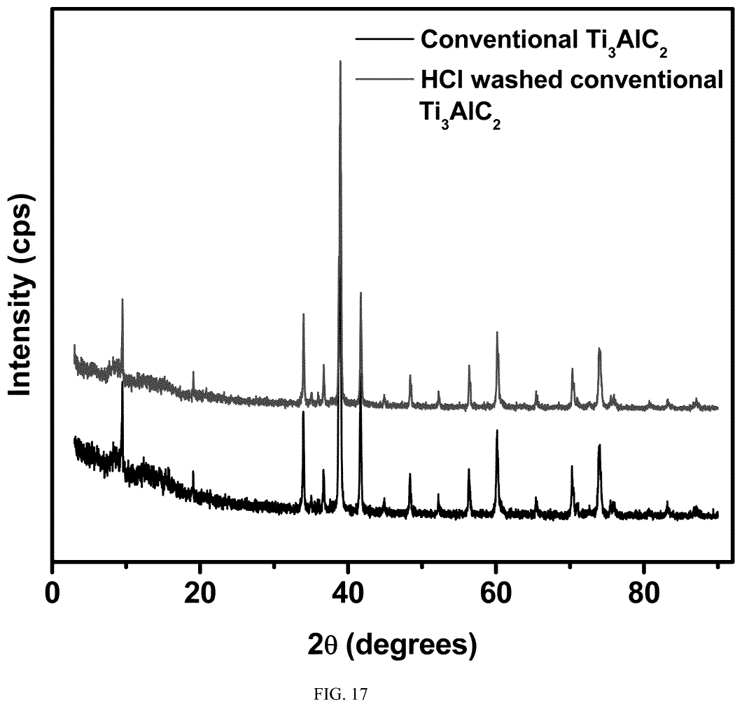

Al—Ti₃AlC₂ MAX was produced by pressureless sintering of a non-stochiometric mixture of TiC, Ti, and Al powders that contained excess Al (see Experimental Methods section). The as-produced MAX contains intermetallic compounds—namely in the form of TiAl₃—as seen in the X-ray diffraction (XRD) pattern of Al—Ti₃AlC₂ (FIG. 12a, red—upper line). The intermetallic impurities cause the body of the block of MAX to have a lustrous, metallic sheen when the sintered block is milled, which is not the case for blocks of Ti₃AlC₂ produced using conventional synthesis methods (FIG. 16). Generally, the use of excess aluminum in the synthesis of MAX phases is known to introduce deleterious impurities into the final sintered product. XRD analysis shows however that these intermetallic impurities can easily be removed by washing the milled Al—Ti₃AlC₂ powder in hydrochloric acid (HCl) at room temperature (FIG. 12a, blue). There were no intermetallics or differences observed in the XRD patterns of conventional Ti₃AlC₂ before and after acid washing (FIG. 17).

To better understand how the excess aluminum affects the composition and bonding within the MAX, we further compared the Al—Ti₃AlC₂ with conventional Ti₃AlC₂ using Raman spectroscopy. The Raman spectra of Al—Ti₃AlC₂ (red, not acid washed) and conventional Ti₃AlC₂ (green, not acid washed) show the presence of TiC in both samples, along with the MAX phase Ti₃AlC₂ (FIG. 12b). The vibrational spectrum of Ti₃AlC₂ consists of seven modes: 3 E_{2g}+2 E_{1g}+2 A_{1g}, where the sharp peak at 201 cm⁻¹ in the spectrum of Ti₃AlC₂ (green) is assigned to the E_{2g} vibration of Ti, Al and C.²⁰ This vibration has a larger full width at half maximum and lower intensity for Al—Ti₃AlC₂ (red).

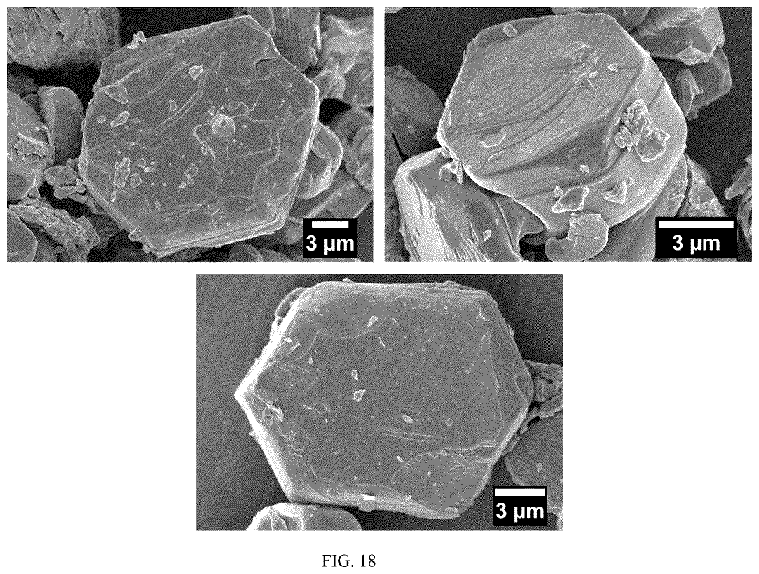

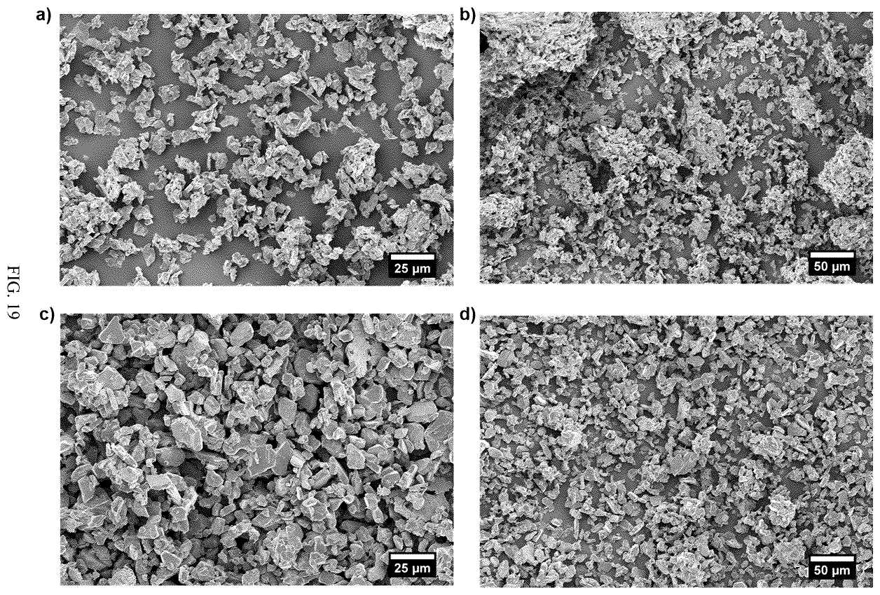

It is worth noting that this is the only observable vibration that involves Al atoms. The broadening and diminishing of this peak in Al—Ti₃AlC₂ suggests some structural changes in the Al layer. The out-of-plane peaks—A_{1g} symmetric and asymmetric—are present in both spectra. However, in the case of Al—Ti₃AlC₂, the symmetric peak shifted slightly from 270 to 274 cm⁻¹ and the asymmetric peak shifted from 659 to 661 cm⁻¹. The positions of the corresponding peaks in Ti₃C₂ are located at 200 and 723 cm⁻¹, respectively. The 300-500 cm⁻¹ region has previously been attributed to impurities, but the exact origin of these peaks has yet to be determined. There is also an additional peak at approximately 549 cm⁻¹ which is present only together with the Ti₃AlC₂, which suggests that the MAX phase is the origin of this peak. The acid washed Al—Ti₃AlC₂ MAX also has well-shaped, hexagonal grains. This may be the result of enhanced diffusion of the reactants during the sintering process caused by the presence of molten aluminum (FIG. 12c and FIG. 18). Comparing low magnification SEM images of the conventional Ti₃AlC₂ and the Al—Ti₃AlC₂ shows clear differences in the overall morphology of the grains of two MAX phases (FIG. 19). The conventional Ti₃AlC₂ is composed of irregular, globular particles while the Al—Ti₃AlC₂ is predominately made up of hexagonal, platelet-like particles. Without being bound to any particular theory, MAX-phase material that comprises an excess of element A can be characterized as being regular, platelet-like particles, whereas MAX-phase material that does no contain such an excess of element A can be characterized as being globular and less regular in form than A-excess MAX-phase materials.

We etched the HCl washed Al—Ti₃AlC₂ using a mixture of hydrofluoric and hydrochloric acids (HF/HCl etching) and then delaminated the MXene by stirring the etched Al—Ti₃C₂ in an aqueous solution of LiCl.

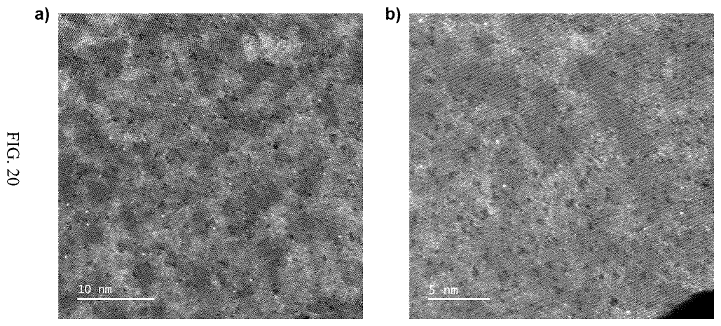

This procedure yields suspensions of delaminated Al—Ti₃C₂ flakes that largely retain the shape of the starting Al—Ti₃AlC₂ MAX particles (FIG. 12d). High-resolution scanning transmission electron microscopy (HRSTEM) images of the edges of conventional Ti₃C₂ (FIG. 12e, top) and Al—Ti₃C₂ (FIG. 12e, bottom) flakes show that the edges of Al—Ti₃C₂ are smoother, without any of the protuberances seen in the conventional Ti₃C₂. Images of the basal planes of both flakes look similar (FIG. 20).

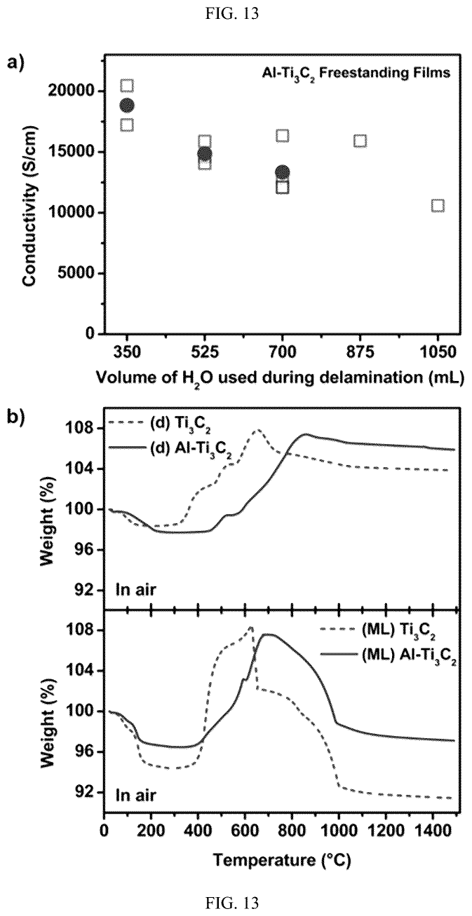

One of the characteristic properties of MXenes, and Ti₃C₂ in particular, is the high electronic conductivity of films produced from solutions of single- or few-layer MXene flakes. Freestanding films made by vacuum filtering Al—Ti₃C₂ solutions have conductivities ranging from slightly higher than 10,000 S/cm up to values exceeding 20,000 S/cm (FIG. 13a). It is important to note, that the electronic conductivity of a MXene film depends not only on the quality of the MXene, but also on the film structure and morphology. Features such as flake alignment, film roughness, and interflake distance influence the conductivity of MXene films. The conductivities of the films produced in this study (>20,000 S/cm) exceed the values reported in recent years for Ti₃C₂ freestanding films and coatings (ranging from 8,000 to 15,000 S/cm).

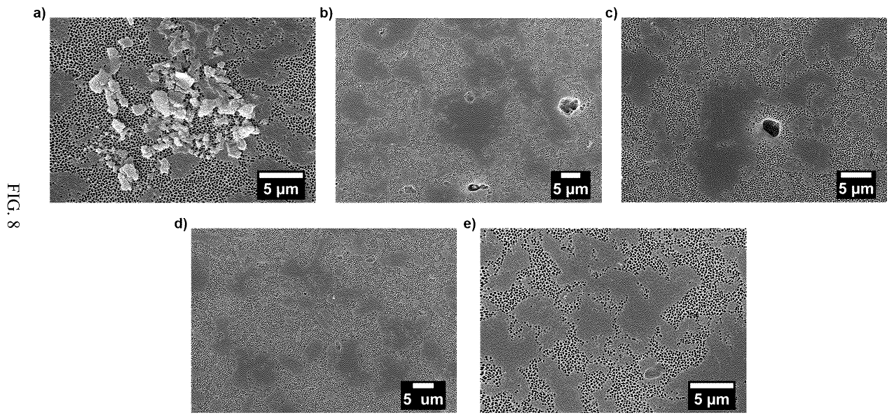

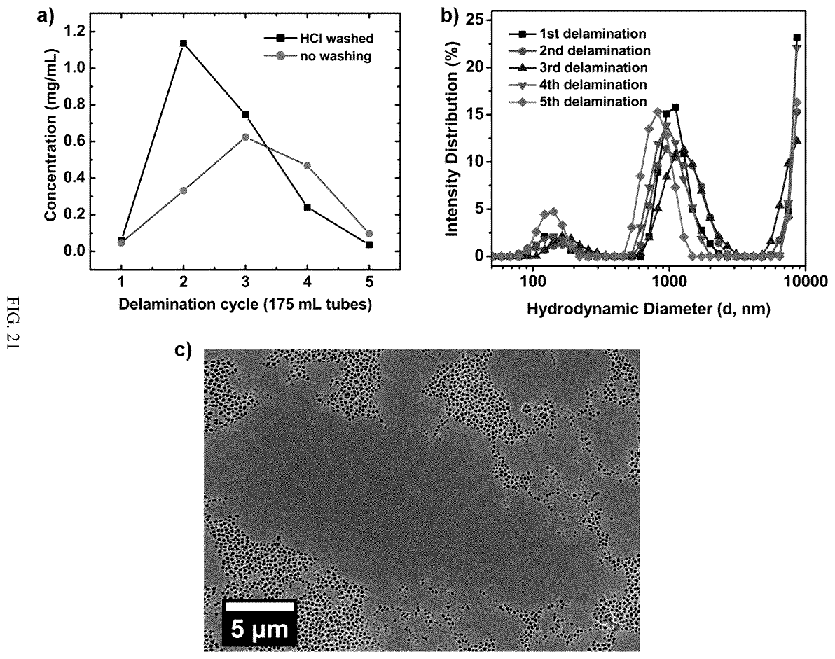

The conductivity of the Al—Ti₃C₂ films varies slightly depending on the quantity of water used during the delamination process (FIG. 13a). Since the concentration of the delaminated Al—Ti₃C₂ colloidal solutions is also dependent on the quantity of water used during delamination (FIG. 21), it is likely that the highest quality single-layer flakes delaminate first, leading to the highest quality films. However, traces of LiCl present in the MXene solutions in the initial stages of delamination may also influence the properties of the final films. We find that as the delamination process continues, the remaining LiCl is removed (FIG. 8).

Thermogravimetric analysis (TGA) of delaminated film and multilayer powder Ti₃C₂ samples conducted in air shows that Al—Ti₃C₂ has significantly improved oxidation stability versus Ti₃C₂ produced from conventional Ti₃AlC₂ (FIG. 13b). During the initial stage of heating (below 200° C.), each sample shows mass loss due to the removal of water that was intercalated between the layers or adsorbed on the surfaces of the MXene samples.

Weight gain due to oxidation begins at ˜150° C. higher for the delaminated Al—Ti₃C₂ versus the conventional Ti₃C₂. Oxidation of the Al—Ti₃C₂ multilayer powder, where the flake edges are exposed and no continuous protective oxide can form, occurs at a much slower rate than the conventional Ti₃C₂, indicating that the oxidation stability of solid films and powders of Al—Ti₃C₂ is improved in air. Moreover, the high-temperature resistance of the delaminated Al—Ti₃C₂ in air is improved by approximately 200° C. over literature reports, up to over 450° C. This characteristic thus expands the use of MXenes to applications requiring operation at elevated temperatures in air, such as sensors or electronics operating near hot engines or electrical components.

A notable property of the Al—Ti₃C₂ produced from HCl-washed Ti₃AlC₂ MAX is its remarkable shelf life as an aqueous colloidal suspension. To test the long-term stability of the Al—Ti₃C₂ solutions, we took the minimum amount of precautions to protect the Al—Ti₃C₂ flakes, as to simulate the most typical laboratory storage conditions. Delaminated Al—Ti₃C₂ solutions were degassed by bubbling argon through the solutions at the as-produced concentration directly after centrifugation before the solutions were transferred to sealed, argon-filled vials and then stored away from light in a laboratory bench drawer at room temperature. This is a common way of preparing colloidal solutions for shipment or storage that requires no specialized equipment, deep refrigeration, or stabilizing additives.

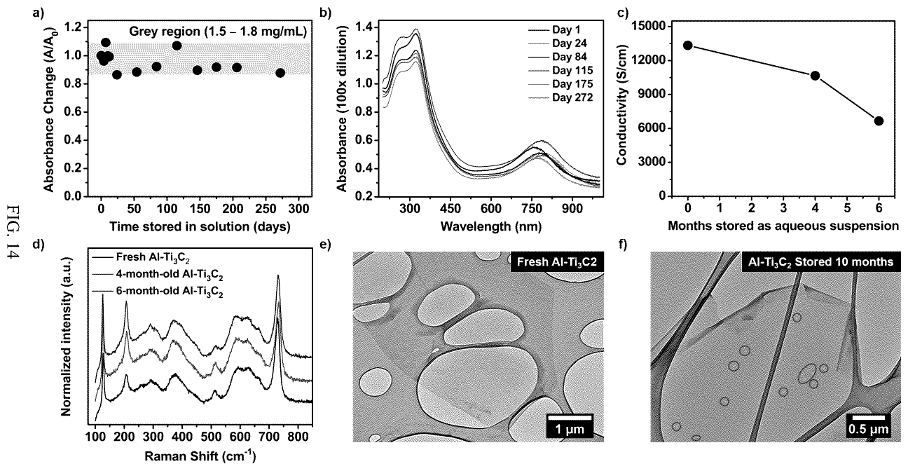

Changes in the suspension's absorbance over time based on UV-Vis measurements recorded periodically during the storage period show that the concentration of the suspension remains relatively unchanged (FIG. 14a). In addition, no noticeable changes in the UV-vis spectra of the stored samples occurred until the 4-month mark (FIG. 14b), where a slight red-shift of the 768 nm peak to 780 nm occurs. Red-shifts of this peak have been shown to be caused by changes in the oxidation state of the Ti in Ti₃C₂.

When a film was made from the solution that was stored for 4 months, the conductivity was still over 10,000 S/cm, well within the range of measurements made from films directly after delamination (FIG. 14c). After 6 months of storage, the UV-vis spectra of the Al—Ti₃C₂ solution still had only a slight red-shift in the ˜780 nm peak, but the conductivity of the film made from the 6-month-old solution dropped to just over 6000 S/cm. The Raman spectra of the Al—Ti₃C₂ films made from fresh, 4-month-old, and 6-month-old solutions are identical. No photoluminescent background is present, meaning there was no titanium oxide formation during storage (FIG. 14d). Minor oxidation begins after approximately 4 months for these storage conditions, as determined by the decrease in electronic conductivity.

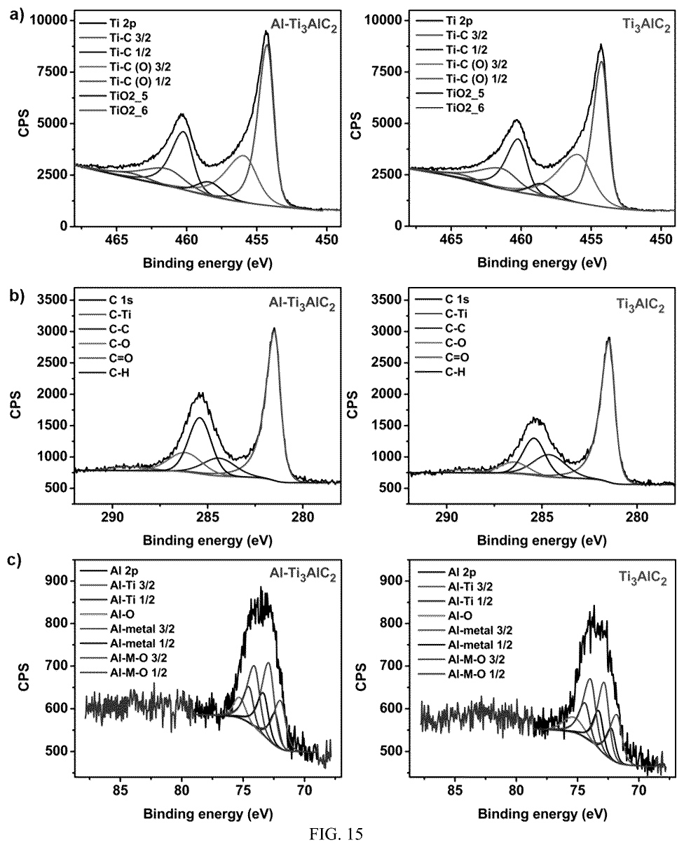

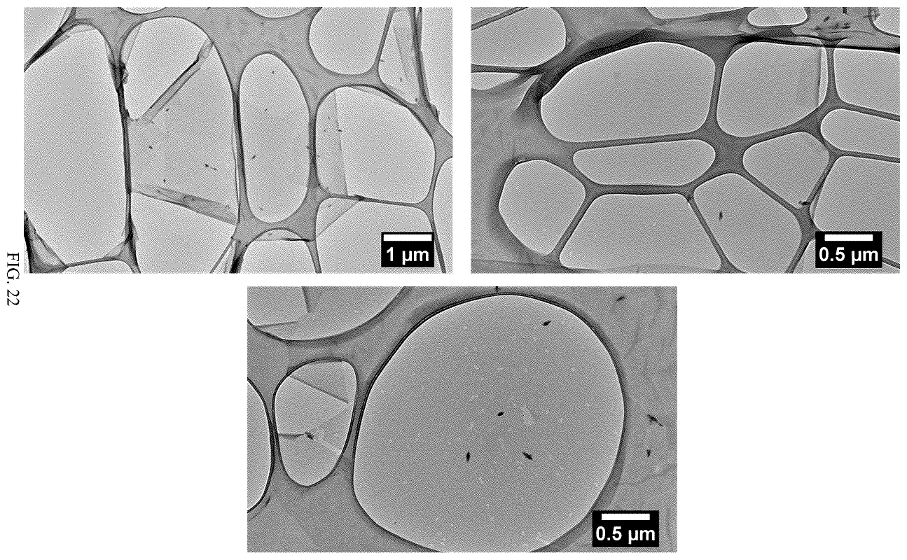

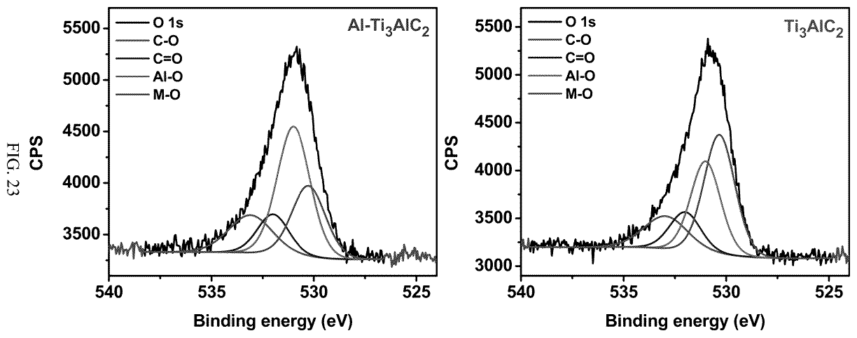

Comparison of TEM images of fresh Al—Ti₃C₂ flakes and Al—Ti₃C₂ flakes stored for 10 months exhibit remarkably few pinholes (commonly observed in samples stored for extended periods (FIG. 14e, 14f) and very few TiO₂ crystals after nearly a year of storage (FIG. 22). From the core level X-ray photoelectron spectra (XPS), there were negligible differences in the chemical environments of Ti, C, and Al (FIGS. 15a, 15b, and 15c, respectively) between the Al—Ti₃AlC₂ and conventional Ti₃AlC₂ MAX phases. However, close inspection of the O region reveals that there is less oxygen in Al—Ti₃AlC₂, potentially in the form of oxycarbides (FIG. 23). This may contribute to the improved oxidation stability of the resulting Al—Ti₃C₂. The straight edges of the Al—Ti₃C₂ flakes show no traces of oxides after being exposed to air for a few days prior to the TEM measurements, which is another sign that the Al—Ti₃C₂ is highly stable. It is known the that oxidation of Ti₃C₂ starts from point defects and edges and it was proposed that stabilization of the edges of the flakes by adsorbed species can improve the oxidation stability of Ti₃C₂.

Conventionally, aqueous solutions of Ti₃C₂ will be completely oxidized after just a few weeks of storage in ambient conditions. In contrast, the shelf life of Al—Ti₃C₂ solutions can be for months or years; one can also store samples at temperatures near or below freezing to slow oxidation or by concentrating the Al—Ti₃C₂ solutions to concentrations of tens or even hundreds of mg/mL by high speed centrifugation to reduce the total amount of water in the solutions.

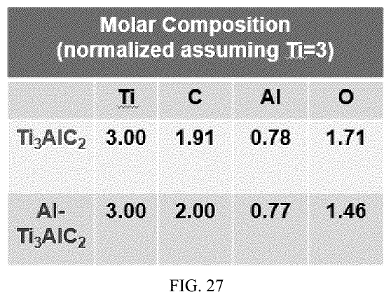

Recent results show that freezing Ti₃C₂ solutions allows for storage for multiple years. But with the disclosed technology, one can achieve similar results under ambient conditions with Al—Ti₃C₂. These results are evidence that the improved oxidation stability of Al—Ti₃C₂ may be likely due to a reduction in the number of defects in the MAX synthesized with excess aluminum, which would then result in MXene flakes that are less defective and have improved Ti:C stoichiometry (FIG. 27).

It has been reported that Al monovacancies (V_{Al}), Al divacancies (2V_{Al—Al}), and divacancies composed of Al and C atoms (2V_{Al—C}) are the most easily formed vacancies in Ti₃AlC₂. Therefore, the presence of excess aluminum may (without being bound to any particular theory) play a role in minimizing carbon vacancies and reduce the associated loss of Ti atoms near carbon vacancies after etching, leading to Ti₃C₂ flakes with fewer defects. In any event, even without a complete understanding of the exact origin of the dramatic improvement in the stability of Al—Ti₃C₂, the results presented in the present disclosure establish the formation of highly stable MXenes.

In prior work, researchers selecting MAX phase precursors for MXene synthesis were solely concerned with the phase purity of the MAX. Our results show that the optimization of MAX phase synthesis should aim to improve the properties of the resulting MXenes. As of now, the crystallinity and M:X stoichiometric ratio of the MAX appear to be noteworthy considerations.

### Non-Limiting Conclusions

By modifying the synthesis of Ti₃AlC₂ to produce a more stoichiometric MAX phase with improved structure, we have significantly improved the quality of the resulting Ti₃C₂ MXene flakes, thereby markedly improving the shelf life and stability of the MXene. Doing so significantly improves both the commercial viability of MXenes and the ease with which MXenes can be studied. Storage of the improved Ti₃C₂ in closed vials at room temperature for 10 months with minimal degradation has been demonstrated. Additionally, the improved flake quality resulted in MXene films with higher electronic conductivity, approaching 20,000 S/cm—the highest value reported for any solution processable 2D material reported thus far. The oxidation stability of the MXene in air was also significantly improved, increasing the onset of oxidation by ˜150° C. We anticipate that this new methodology will be used as a guide to improve the oxidation stability and electronic conductivity of a large variety of carbide MXenes.

### Experimental Methods

### Al—Ti₃AlC₂ MAX Synthesis

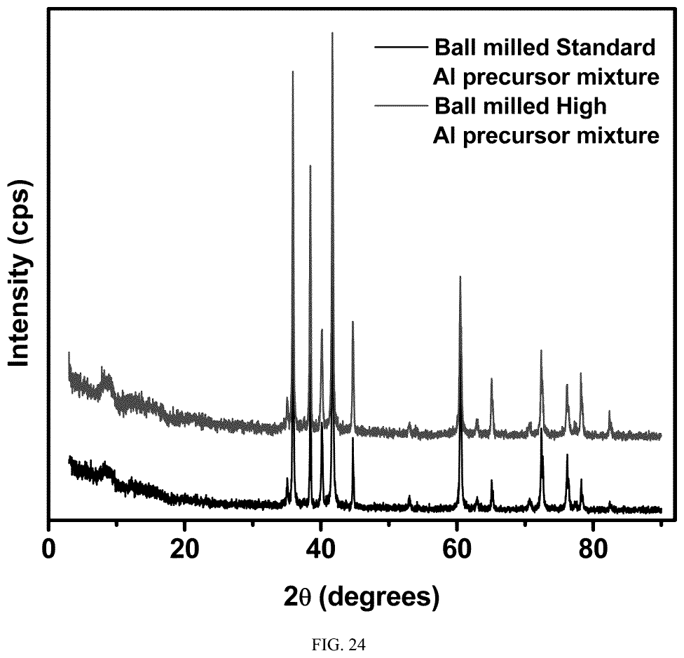

TiC (Alfa Aesar, 99.5%, 2 micron powder), Ti (Alfa Aesar, 99.5%, 325 mesh), and Al (Alfa Aesar, 99.5%, 325 mesh) powders were mixed in a 2:1.25:2.2 molar ratio and then ball milled using yttria stabilized zirconia milling media (Inframat Advanced Materials, 12 mm diameter) for 18 h continuously at 70 rpm in high density polyethylene bottles. A 2:1 mass ratio of zirconia milling media to precursor powder mixture was used. Upwards of 100 g of precursor powder was ball milled in 250 mL bottles, for smaller bottles were used for smaller batches. The precursor powder was not sieved after being ball milled. The only observable differences in XRD patterns of the precursor mixtures for the standard aluminum content Ti₃AlC₂ and the high aluminum Ti₃AlC₂ following ball milling was an increased intensity of the peaks of the aluminum metal in the high Al content precursor mixture, no new phases or alloying was observed (FIG. 24).

The ball milled precursor powder was then packed into an alumina crucible and covered with graphite foil and placed into a tube furnace. The furnace was purged with argon for 30 min at room temperature. After purging, the precursor powders were heated to 1380° C. and held for 2 h under a constant argon flow at ˜100 sccm. The heating and cooling rates were both 3° C./min.

The sintered block of Al—Ti₃AlC₂ was then milled using a TiN coated milling bit to produce MAX powder which was subsequently washed using 9 M HCl (Fisher Scientific, USA). Typically, 500 mL of 9 M HCl is sufficient to wash upwards of 50 to 60 g of Al—Ti₃AlC₂. The MAX was washed until the evolution of gas bubbles from the solution stopped.

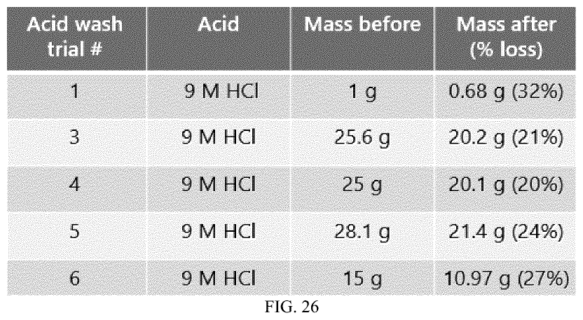

Acid washing of the Al—Ti₃AlC₂ MAX can result in ca. 20-30% loss of mass (FIG. 26) which is primarily attributed to the removal of intermetallic impurities. The acid washed MAX was then neutralized by filtering the Al—Ti₃AlC₂/HCl mixture though a vacuum filtration unit followed by repeated filtration of DI water through the Al—Ti₃AlC₂ deposit. The pore size of the filter membrane used was 5 μm. During neutralization of the acid washed Al—Ti₃AlC₂, the acidic supernatant has a deep purple color (FIG. 16c). The neutralized MAX was then dried in a vacuum oven for at least 6 h at 80° C. The dried Al—Ti₃AlC₂ was then sieved through a 450-mesh (32 μm) particle sieve. The washed, dried, and sieved Al—Ti₃AlC₂ was then etched to produce MXene.

### Ti₃AlC₂ MAX Synthesis

Conventional Ti₃AlC₂ was prepared, synthesized, and acid washed using the same procedure as the Al—Ti₃AlC₂, however a 2:1:1 molar ratio of the TiC, Ti, and Al precursor powders was used.

### Note About Safety During Acid Washing of MAX Powder

During acid washing of metal-rich MAX powder (e.g. Al—Ti₃AlC₂) it is important to note that during the initial stage of the reaction (the first 20 minutes) significant amounts of gas will be produced as the intermetallic impurities are dissolved. In order to minimize the rate at which gas is produced and reduce the danger involved in this reaction we recommend taking the following precautions: (1) Perform the acid washing reaction in an ice bath. Once the reaction is no longer bubbling vigorously the ice bath can be removed or the ice can be allowed to melt. (2) Add MAX to the acid washing solution very slowly, at a rate of approximately 1 g per minute. (3) After all MAX has been added to the acid washing solution, monitor the reaction closely for at least 30 minutes to ensure no sudden changes in the gas evolution rate occur. (4) At no point during the acid washing process should the reaction vessel be capped, as the vessel could potentially pressurize rapidly, leading to an extremely dangerous situation.

### MXene Synthesis

Typically, 1 g of Al—Ti₃AlC₂ (or conventional Ti₃AlC₂) was mixed with 20 mL of etchant and stirred at 400 rpm for 24 h at 35° C. The etchant was a 6:3:1 mixture (by volume) of 12 M HCl, DI water, and 50 wt. % HF (Acros Organics, Fair Lawn, NJ, USA). A loosely capped 60 mL high density polyethylene bottle was used as the etching container. The etched Al—Ti₃C₂ was washed with DI water via repeated centrifugation and decantation cycles until the supernatant reached pH ˜6 using a 175 mL centrifuge tube. Once the MXene was neutralized, one more additional wash cycle was performed to ensure the washing process was complete. 5 wash cycles using a single 175 mL centrifuge tube are typically enough for 1 g of MAX etched using 20 mL of etchant.

The etched multilayer MXene sediment was then dispersed in a 0.5 M solution of LiCl (typically 50 mL solution per gram of starting MAX) to start the delamination process. The MXene/LiCl suspension was then stirred at 400 rpm for a minimum of 4 h at room temperature. The MXene/LiCl suspension was then washed with DI water via repeated centrifugation and decantation of the supernatant using a 175 mL centrifuge tube.

The first wash cycle always sediments completely after 3 to 5 minutes of centrifugation at 3500 rpm. The second wash cycle and onwards were centrifuged for 1 h at 3500 rpm before the MXene supernatants were collected to ensure the MXene solutions were single flake.

The quantity and concentration of the delaminated MXene suspensions produced during each cycle of the delamination process is dependent on the quantity of the MAX that was etched and on the size of the centrifuge tubes used during delamination (FIG. 19a). The solution concentrations and yield reported in this study are typical for etching 1 g of Al—Ti₃AlC₂ in 20 mL of etchant and using 175 mL centrifuge tubes for delamination.

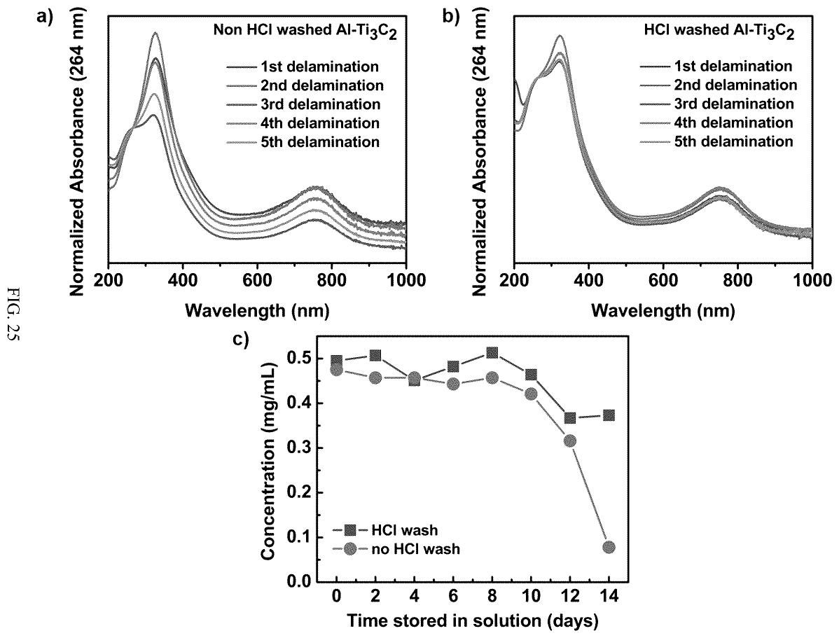

Large, single-layer Al—Ti₃C₂ flakes (>25 μm in the largest dimension, FIG. 19c) can be readily obtained using this method, but it must be noted that the flake sizes of the Al—Ti₃C₂ flakes produced are polydisperse, with average flake sizes of 1.3 to 1.6 μm (FIG. 19b). If a narrow flake size distribution range is desired, then separation of the MAX phase into fractions with narrow distributions of particle sizes and/or density gradient centrifugation of colloidal solutions of MXene can be employed to isolate flakes of the desired size.³² It is important to note that acid washing the Al—Ti₃AlC₂ prior to etching is crucial for achieving high stability suspensions as any residual ions from the intermetallic impurities may cause the suspensions to flocculate (FIG. 25).

### Physical Characterization

Conductivity measurements were performed using a four-point probe with 1 mm probe separation (Jandel Engineering Ltd., Bedfordshire, UK) on freestanding MXene films made by vacuum-assisted filtration of delaminated single flake MXene solutions. The measured sheet resistances of the films were converted into conductivity by using the thickness of the films taken from SEM images of the film cross sections. UV-Vis spectra were recorded using an Evolution 201 spectrometer (Thermo Scientific, MA, USA) with a 10 mm optical path length cuvette and scanning from 200 to 1000 nm, where the absorbance was measured for samples at 100× dilution.

Particle size analysis was performed using a Malvern Panalytical Zetasizer Nano ZS in a polystyrene cuvette. Three measurements were recorded, and the average intensity distribution was reported. For the long-term storage tests, solutions from the 3rd delamination cycle (700 mL) were used since any excess LiCl would have been removed by that cycle.

The concentrations of the stored Ti₃C₂ samples were calculated by measuring the absorbance changes of the samples over time versus the absorbance of the Ti₃C₂ samples at the initial time of storage, normalized at 264 nm. Raman spectra were recorded using a reflection mode Renishaw In Via spectrometer (Renishaw plc, Gloucestershire, UK) equipped with 20× (NA=0.4) and 63× (NA=0.7) objectives and a diffraction-based room-temperature CCD spectrometer.

For MAX phase analysis, we used an Ar+ laser (488 and 514 nm emissions) and an 1800 line/mm grating, and for analysis of MXene we used a diode (785 nm) laser with a 1200 line/mm diffraction grating. The power of the lasers was within the ˜0.3-1 mW range. Transmission electron microscopy and scanning transmission electron microscopy images were taken using a JEOL JEM2100 and JEOL NEOARM (JEOL Ltd., JP), respectively, at an operating voltage of 200 kV. The colloid solution containing delaminated Al—Ti₃C₂ flakes was drop-cast onto lacey carbon films on copper TEM grids (Electron Microscopy Sciences, PA, USA).

Thermal analysis (TGA) measurements were conducted using an SDT 650 thermal analysis system (TA Instruments, New Castle, DE, USA). Samples were heated at 10° C./min from room temperature to 1500° C. under constant flow of compressed dry air at 100 sccm.

Samples for thermal analysis were equilibrated overnight in vials exposed to ambient atmosphere. XPS spectra were collected on MAX powder using a PHI VersaProbe 5000 instrument (Physical Electronics, USA) with a 200 μm and 50 W monochromatic Al—K_{α} X-ray source. Samples were sputtered for 10 min at 2 kV, 2 uA with Ar⁺ ion beam. Pass energy and step size were set at 23.5 eV and 0.05 eV, respectively. Quantification and peak fitting were conducted using CasaXPS V2.3.19 Software.

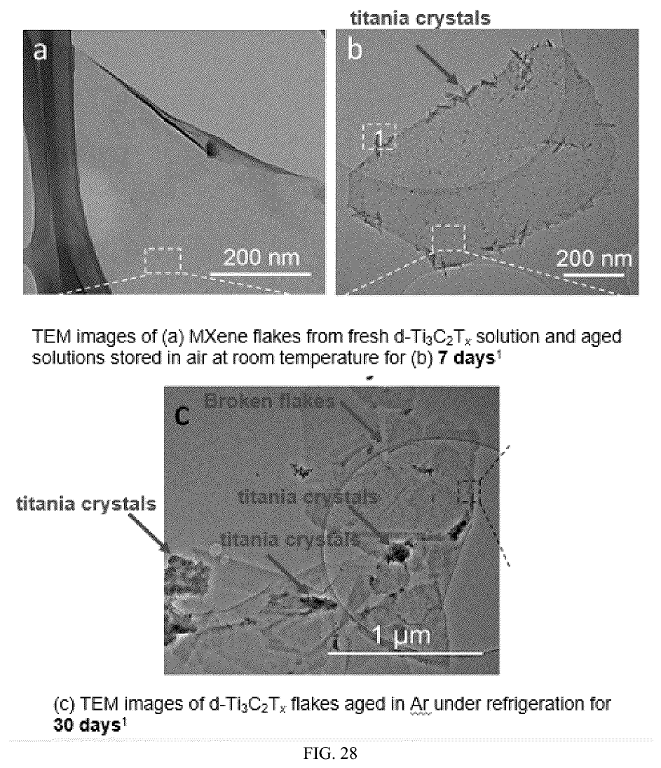

Comparative data are provided in FIGS. 28a-28c to FIG. 34. As shown in FIGS. 28a-28, MXene flakes that are made from a MAX phase material that does not include an excess of the A-element develop titania crystals within 7 days of storage. By 30 days, the flakes exhibit titania crystals and broken flakes, both of which are evidence of MXene degradation.

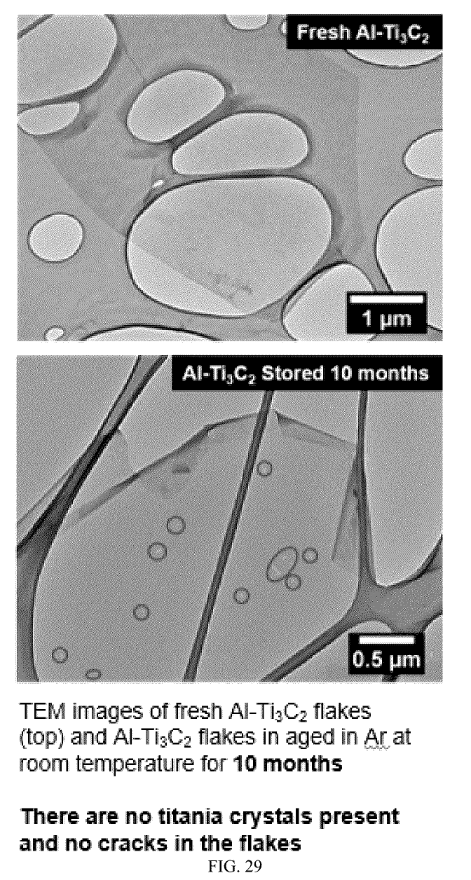

By contrast, MXene materials made according to the present disclosure (as shown in FIG. 29) exhibit neither titania crystals nor broken flakes even after 10 months of storage under Ar at room temperature; i.e., the fresh flakes and the flakes aged for 10 months are essentially identical, thus underscoring the storage stability of the disclosed technology.

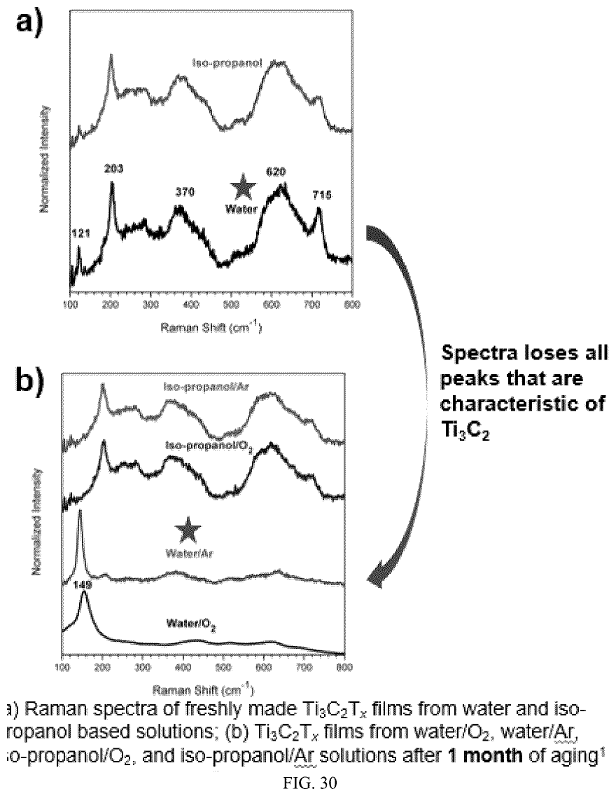

FIGS. 30a-30b show the changes in Raman spectra experienced by MXene films when stored under water and isopropanol for 1 month; as shown, the spectra of these samples lost the peaks characteristic of MXene materials.

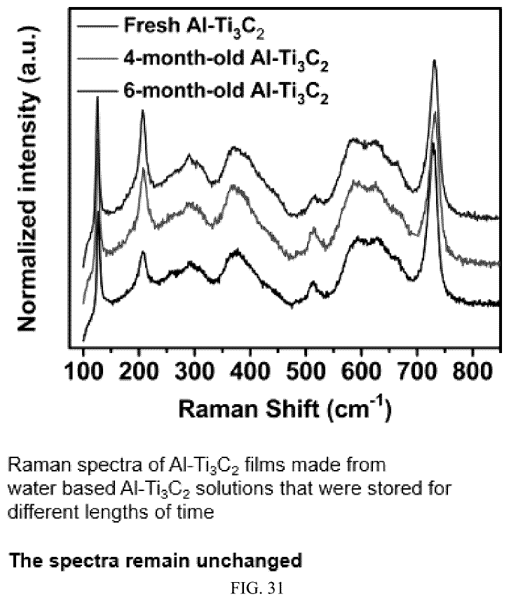

By contrast, Raman spectra (FIG. 31) for materials made according to the disclosed technology do not exhibit the degradation shown in FIG. 30 and, instead, retain their MXene characteristic peaks, even after storage for 6 months.

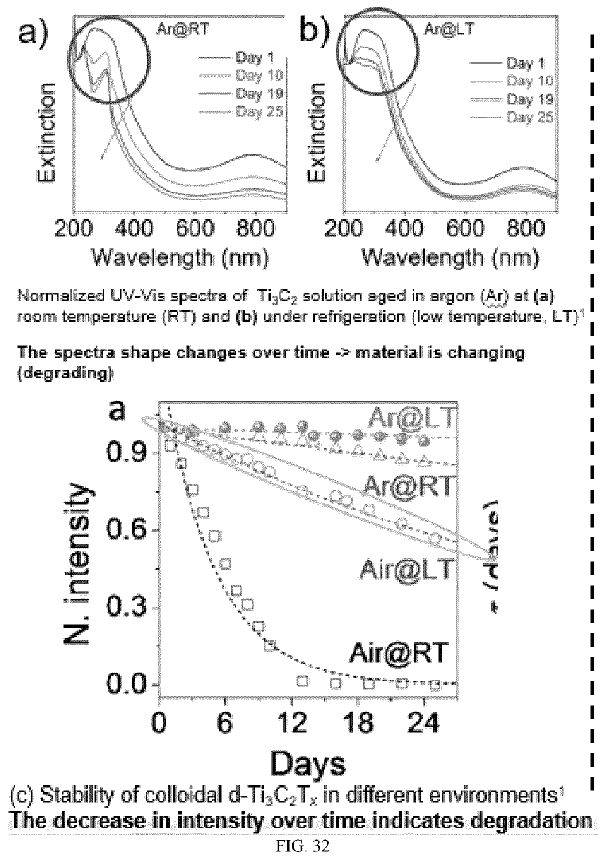

Further evidence of the stability of the disclosed materials is provided in FIGS. 32a-32b. As shown in those figures, normalized UV-Vis spectra for a MXene solution aged under Ar at room temperature (RT) and under refrigeration (LT) exhibit a spectral shape change over time, which spectral shape change evidences the degradation of the MXene material. As shown in FIG. 32c, standard MXene materials exhibit a change in spectral intensity over time (particularly when stored in air), which decrease in intensity is evidence of material degradation.

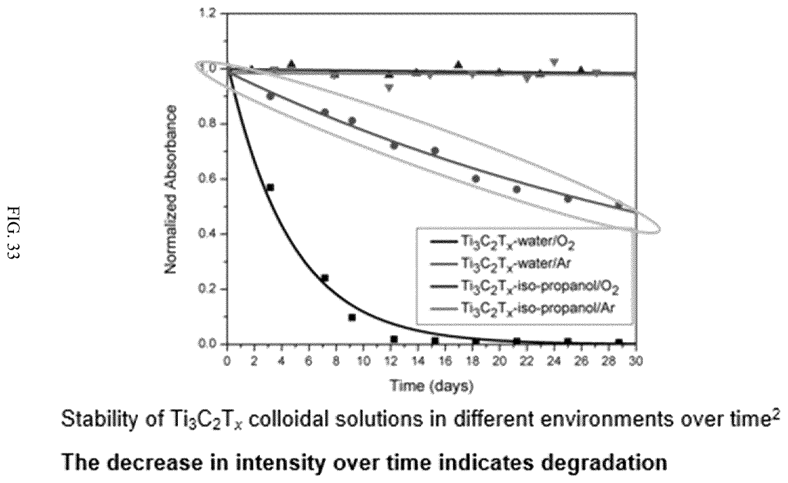

FIG. 33 provides a normalized absorbance for colloidal MXene solutions over time under different storage conditions. As shown, the materials exhibit a reduction in normalized absorbance (particularly for materials stored under water, O₂, and air), which change in absorbance is evidence of MXene material degradation.

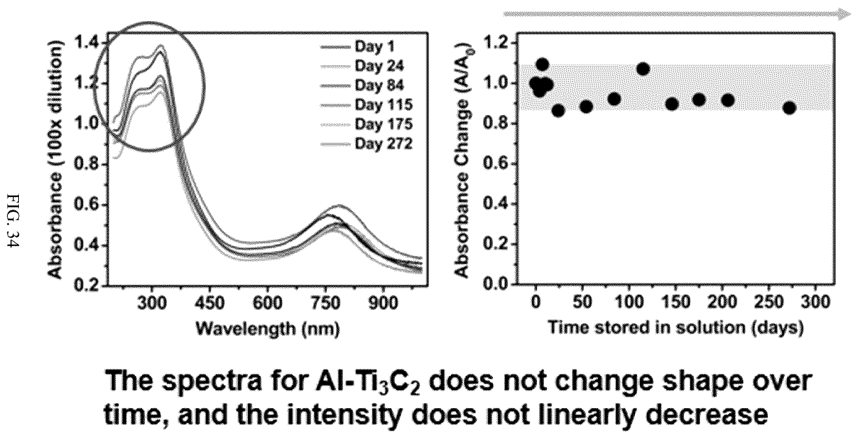

FIG. 34 provides comparative data for materials made according to the present disclosure. As shown in FIG. 34, the spectra for the Al—Ti₃C₂ MXenes do not appreciably change shape over time, which shape maintenance shows the storage stability of the materials. Likewise, there is little to no change in absorbance over time, which unchanged absorbance is evidence of the materials' stability.

### Embodiments

The following embodiments are exemplary only and do not limit the scope of the present disclosure or the appended claims.

Embodiment 1. A composition having enhanced storage stability, comprising: a substantially two-dimensional array of crystal cells, each crystal cell having an empirical formula of Mₙ₊₁Xₙ, such that each X is positioned within an octahedral array of M, wherein M is at least one Group IIIB, IVB, VB, or VIB metal, wherein each X is C, N, or a combination thereof; n=1, 2, 3, or 4, wherein at least one of said surfaces of each layer has surface terminations comprising alkoxide, carboxylate, halide, hydroxide, hydride, oxide, sub-oxide, nitride, sub-nitride, sulfide, thiol, or a combination thereof, and wherein, following storage in degassed deionized water at 25 deg. C. for 4 months, (a) stored composition exhibits an essentially unchanged UV-vis spectra between 200 and 1000 nm as compared to comparable composition that has not been stored, (b) a film formed from stored composition exhibits a conductivity between about 10,000 and 15,000 S/cm, (c) stored composition exhibits an essentially unchanged XPS spectra from a survey scan of the 2p region of M, or any combination of (a), (b), and (c).

Embodiment 2. The composition of Embodiment 1, wherein M is at least one Group IVB, Group VB, or Group VIB metal.

Embodiment 3. The composition of Embodiment 1, wherein M is Ti, and n is 1 or 2.

Embodiment 4. The composition of Embodiment 1, wherein Mₙ₊₁Xₙ comprises Sc₂C, Sc₂N, Ti₂C, Ti₂N, V₂C, V₂N, Cr₂C, Cr₂N, Zr₂C, Zr₂N, Nb₂C, Nb₂N, Hf₂C, Hf₂N, Ti₃C₂, Ti₃N₂, V₃C₂, Ta₃C₂, Ta₃N₂, Ti₄C₃, Ti₄N₃, V₄C₃, V₄N₃, Ta₄C₃, Ta₄N₃, or a combination thereof.

Embodiment 5. The composition of Embodiment 1, wherein Mₙ₊₁Xₙ comprises Ti₃C₂, Ti₃CN, Ti₂C, Ta₄C₃ or (V_{1/2}Cr_{1/2})₃C₂.

Embodiment 6. The composition of Embodiment 1 wherein M is Ta, and n is 2 or 3.

Embodiment 7. The composition of Embodiment 1, the crystal cells having an empirical formula Ti₃C₂ or Ti₂C and wherein at least one of said surfaces of each layer has surface terminations comprising hydroxide, oxide, sub-oxide, or a combination thereof.

Embodiment 8. The composition of Embodiment 1, wherein the composition comprises an electrically conductive or semiconductive surface.

Embodiment 9. The composition of Embodiment 1, wherein M is at least one of Sc, Y, Lu, Ti, Zr, Hf, V, Nb, Ta, Cr, Mo, or W.

Embodiment 10. A device, comprising a composition according to any one of Embodiments 1-9.

Embodiment 11. A method, comprising fabricating a composition according to any one of Embodiments 1-9.

Embodiment 12. A method of preparing a composition, comprising: removing substantially all of the A atoms from a MAX-phase composition having an empirical formula of Mₙ₊₁AXₙ and comprising an excess of A, M, and/or X, wherein M is at least one Group IIIB, IVB, VB, or VIB metal, wherein A is an A-group element, each X is C, N, or a combination thereof, and n=1, 2, 3, or 4; thereby providing a composition comprising at least one layer having a first and second surface, each layer comprising a substantially two-dimensional array of crystal cells, each crystal cell having an empirical formula of Mₙ₊₁Xₙ, such that each X is positioned within an octahedral array of M, and wherein at least one of said surfaces of each layer has surface terminations comprising alkoxide, carboxylate, halide, hydroxide, hydride, oxide, sub-oxide, nitride, sub-nitride, sulfide, thiol, or a combination thereof.

Embodiment 13. The method of Embodiment 12, wherein the A atoms are removed by a process comprising a treatment with a fluorine-containing acid.

Embodiment 14. The method of Embodiment 13, wherein the fluorine-containing acid is aqueous hydrofluoric acid.

Embodiment 15. The method of Embodiment 12, further comprising sonication. Sonication can be performed by, e.g., ultrasonic or megasonic sources.

Embodiment 16. The method of Embodiment 15, wherein the MAX-phase composition comprises an excess of A, and optionally wherein the MAX-phase material contains essentially stoichiometric amounts of M and X.

Embodiment 17. The method of Embodiment 12, wherein removing substantially all of the A atoms from a MAX-phase composition is done electrochemically.

Embodiment 18. A method, comprising: with a MAX-phase composition having an empirical formula of Mₙ₊₁AXₙ and comprising an amount of MA intermetallic impurities, the MAX-phase composition optionally being formed from thermal treatment of an about 2:1:1 mass ratio of MX, M, and A particulate, removing substantially all of the A atoms from the MAX-phase composition, and removing substantially all of the intermetallic impurities from the MAX-phase composition.

Embodiment 19. A method, comprising: combining amounts of a metal M, a composition MX, and a metal A to form a mixture, the mixture (a) comprising an amount of the metal A that is in excess of the amount needed to make a stoichiometric amount of a MAX-phase material formed from M, MX, and A, (a) comprising an amount of the composition MX that is in excess of the amount needed to make a stoichiometric amount of a MAX-phase material formed from M, MX, and A, (c) comprising an amount of the metal M that is in excess of the amount needed to make a stoichiometric amount of a MAX-phase material formed from M, MX, and A, or any combination of (a), (b), and (c); treating the mixture so as to give rise to a MAX-phase material, optionally removing substantially all of the A atoms from the MAX-phase composition, and optionally removing substantially all of the intermetallic impurities from the MAX-phase composition.

Embodiment 20. A composition having enhanced storage stability, comprising:
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof;
n=1, 2, 3, or 4,
wherein at least one of said surfaces of each layer has surface terminations comprising alkoxide, carboxylate, halide, hydroxide, hydride, oxide, sub-oxide, nitride, sub-nitride, sulfide, thiol, or a combination thereof, and
wherein, said composition is formed from removing essentially all of metal A from a MAX-phase material comprising metal M, element X, and an excess of metal A.

Embodiment 21. The composition of Embodiment 20, wherein the composition, when heated in air, exhibits an onset of weight gain at a higher temperature than a comparable composition formed from removing essentially all of metal A from a MAX-phase material comprising stoichiometric amounts of metal M, element X, and metal A.

Embodiment 22. The composition of any one of Embodiments 20 to 21, wherein the composition, when heated in air, achieves a weight gain of a given percentage at a temperature higher than a temperature at which a comparable composition formed from removing essentially all of metal A from a MAX-phase material comprising stoichiometric amounts of metal M, element X, and metal A achieves the weight gain of the given percentage.

Embodiment 23. A composition having enhanced storage stability, comprising:
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof;
n=1, 2, 3, or 4, and
wherein at least one of said surfaces of each layer has surface terminations comprising alkoxide, carboxylate, halide, hydroxide, hydride, oxide, sub-oxide, nitride, sub-nitride, sulfide, thiol, or a combination thereof, and
wherein the composition has a molar ratio of M:X in the range of from (n+1):0.95n to n+1:1.05n.

Embodiment 24. The composition of Embodiment 23, wherein the composition has a molar ratio of M:X in the range of from (n+1):0.98n to n+1:1.02n.

Embodiment 25. The composition of Embodiment 24, wherein the composition exhibits a molar ratio of M:X in the range of from (n+1):0.995n to n+1:1.005n.

Embodiment 26. The composition of Embodiment 25, wherein the composition exhibits an empirical ratio of M:X of (n+1):1n.

Embodiment 27. A composition having enhanced storage stability, comprising:
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof;
n=1, 2, 3, or 4, and
wherein at least one of said surfaces of each layer has surface terminations comprising alkoxide, carboxylate, halide, hydroxide, hydride, oxide, sub-oxide, nitride, sub-nitride, sulfide, thiol, or a combination thereof, and
(a) wherein the composition exhibits an essentially an essentially unchanged UV-vis spectrum between 200 and 1000 nm after storage in water at room temperature for 30 days,
(b) wherein the composition exhibits an essentially an essentially absorbance at a given wavelength between 200 and 1000 nm after storage in water at room temperature for 30 days
(c) wherein the composition exhibits an essentially an essentially unchanged Raman spectrum between 200 and 1000 nm after storage in water at room temperature for 30 days,
(d) wherein the composition comprises a plurality of flakes and wherein after storage in water at room temperature for 300 days, (1) the flakes are essentially crack-free, (2) the flakes are essentially free of metal oxide crystals formed of M, or both (1) and (2), or
(e) any combination of (a), (b), (c), and (d).

The present disclosure also provides methods of using the disclosed compositions. Any one or more of the compositions can be used in applications in which the composition is exposed to the ambient environment, e.g., in an environmental monitor such as a weather device, an antenna, a speaker, and the like. The disclosed compositions can also be used in applications where they are exposed to relatively higher temperatures, e.g., temperatures of from 350 to 500 deg C. Such applications can include, e.g., propulsion systems, exhaust systems, undersea applications, down-well applications (e.g., subterranean wells), rockets, appliances, medical instrumentation, and the like. Owning to their enhanced temperature tolerance, the disclosed compositions are accordingly suited to particularly demanding applications.

The following references are incorporated by reference in their entireties for any and all purposes.

### REFERENCES

Nicolosi, V.; Chhowalla, M.; Kanatzidis, M. G.; Strano, M. S.; Coleman, J. N., Liquid Exfoliation of Layered Materials. Science 2013, 340 (6139), 1226419.
Novoselov, K. S.; Geim, A. K.; Morozov, S. V.; Jiang, D.; Zhang, Y.; Dubonos, S. V.; Grigorieva, I. V.; Firsov, A. A., Electric Field Effect in Atomically Thin Carbon Films. Science 2004, 306 (5696), 666-669.
Geim, A. K., Graphene: Status and Prospects. Science 2009, 324 (5934), 1530-1534.
Golberg, D.; Bando, Y.; Huang, Y.; Terao, T.; Mitome, M.; Tang, C.; Zhi, C., Boron Nitride Nanotubes and Nanosheets. ACS Nano 2010, 4 (6), 2979-2993.
Wang, Q. H.; Kalantar-Zadeh, K.; Kis, A.; Coleman, J. N.; Strano, M. S., Electronics and optoelectronics of two-dimensional transition metal dichalcogenides. Nature Nanotechnology 2012, 7 (11), 699-712.
Butler, S. Z.; Hollen, S. M.; Cao, L.; Cui, Y.; Gupta, J. A.; Gutiérrez, H. R.; Heinz, T. F.; Hong, S. S.; Huang, J.; Ismach, A. F.; Johnston-Halperin, E.; Kuno, M.; Plashnitsa, V. V.; Robinson, R. D.; Ruoff, R. S.; Salahuddin, S.; Shan, J.; Shi, L.; Spencer, M. G.; Terrones, M.; Windl, W.; Goldberger, J. E., Progress, Challenges, and Opportunities in Two-Dimensional Materials Beyond Graphene. ACS Nano 2013, 7 (4), 2898-2926.
Lv, R.; Robinson, J. A.; Schaak, R. E.; Sun, D.; Sun, Y.; Mallouk, T. E.; Terrones, M., Transition Metal Dichalcogenides and Beyond: Synthesis, Properties, and Applications of Single- and Few-Layer Nanosheets. Accounts of Chemical Research 2015, 48 (1), 56-64.
Sugimoto, W.; Iwata, H.; Yasunaga, Y.; Murakami, Y.; Takasu, Y., Preparation of ruthenic acid nanosheets and utilization of its interlayer surface for electrochemical energy storage. Angewandte Chemie International Edition 2003, 42 (34), 4092-4096.
Osada, M.; Sasaki, T., Exfoliated oxide nanosheets: new solution to nanoelectronics. Journal of Materials Chemistry 2009, 19 (17), 2503-2511.
Ma, R.; Sasaki, T., Nanosheets of oxides and hydroxides: ultimate 2D charge-bearing functional crystallites. Advanced materials 2010, 22 (45), 5082-5104.
Rui, X.; Lu, Z.; Yu, H.; Yang, D.; Hng, H. H.; Lim, T. M.; Yan, Q., Ultrathin V2O5 nanosheet cathodes: realizing ultrafast reversible lithium storage. Nanoscale 2013, 5 (2), 556-560.
Etzkorn, J.; Ade, M.; Hillebrecht, H., Ta3AlC2 and Ta4AlC3—Single-Crystal Investigations of Two New Ternary Carbides of Tantalum Synthesized by the Molten Metal Technique. Inorganic Chemistry 2007, 46 (4), 1410-1418.
Maleski, K.; Ren, C. E.; Zhao, M.-Q.; Anasori, B.; Gogotsi, Y., Size-Dependent Physical and Electrochemical Properties of Two-Dimensional MXene Flakes. ACS Applied Materials & Interfaces 2018, 10 (29), 24491-24498.
Alhabeb, M.; Maleski, K.; Anasori, B.; Lelyukh, P.; Clark, L.; Sin, S.; Gogotsi, Y., Guidelines for Synthesis and Processing of Two-Dimensional Titanium Carbide (Ti3C2Tx MXene). Chemistry of Materials 2017, 29 (18), 7633-7644.
Zhang, C.; Anasori, B.; Seral-Ascaso, A.; Park, S.-H.; McEvoy, N.; Shmeliov, A.; Duesberg, G. S.; Coleman, J. N.; Gogotsi, Y.; Nicolosi, V., Transparent, Flexible, and Conductive 2D Titanium Carbide (MXene) Films with High Volumetric Capacitance. Advanced Materials 2017, 29 (36), 1702678.
Payne, B. P.; Biesinger, M. C.; McIntyre, N. S., X-ray photoelectron spectroscopy studies of reactions on chromium metal and chromium oxide surfaces. Journal of Electron Spectroscopy and Related Phenomena 2011, 184 (1), 29-37.

What is claimed:

1. A composition having enhanced storage stability, comprising:
a layer having a first surface and a second surface and comprising a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof;
n=1, 2, 3, or 4,
wherein at least one of said surfaces of each layer has surface terminations comprising alkoxide, carboxylate, halide, hydroxide, hydride, oxide, sub-oxide, nitride, sub-nitride, sulfide, thiol, or a combination thereof,
the layer being substantially free of intermetallic impurities, and
wherein, following storage in degassed deionized water at 25 deg. C. for 4 months, a film formed from stored composition exhibits a conductivity between about 10,000 and 15,000 S/cm.

2. The composition of claim 1, wherein M is at least one Group IVB, Group VB, or Group VIB metal.

3. The composition of claim 1, wherein M is Ti, and n is 1 or 2.

4. The composition of claim 1, wherein Mₙ₊₁Xₙ comprises Sc₂C, Sc₂N, Ti₂C, Ti₂N, V2C, V2N, Cr₂C, Cr₂N, Zr, Zr₂N, Nb₂C, Nb₂N, Hf₂C, Hf₂N, Ti₃C₂, Ti₃N₂, V₃C₂, Ta₃C₂, Ta₃N₂, Ti₄C₃, Ti₄N₃, V₄C₃, V₄N₃, Ta₄C₃, Ta₄N₃, or a combination thereof.

5. The composition of claim 1, wherein Mₙ₊₁Xₙ comprises Ti₃C₂, Ti₃CN, Ti₂C, Ta₄C₃ or (V_{1/2}Cr_{1/2})₃C₂.

6. The composition of claim 1 wherein M is Ta, and n is 2 or 3.

7. The composition of claim 1, the crystal cells having an empirical formula Ti₃C₂ or Ti₂C and wherein at least one of said surfaces of each layer has surface terminations comprising hydroxide, oxide, sub-oxide, or a combination thereof.

8. The composition of claim 1, wherein the composition comprises an electrically conductive or semiconductive surface.

9. The composition of claim 1, wherein M is at least one of Sc, Y, Lu, Ti, Zr, Hf, V, Nb, Ta, Cr, Mo, or W.

10. The composition of claim 1, wherein, following storage in degassed deionized water at 25 deg. C. for 4 months, stored composition exhibits an essentially unchanged UV-vis spectra between 200 and 1000 nm as compared to comparable composition that has not been stored.

11. The composition of claim 1, wherein, following storage in degassed deionized water at 25 deg. C. for 4 months, stored composition exhibits an essentially unchanged XPS spectra from a survey scan of the 2p region of M.

12. A method of preparing a composition, comprising:
removing substantially all of the A atoms from a MAX-phase composition having an empirical formula of Mₙ₊₁AXₙ and comprising an excess of at least one of A, M, and/or X,
wherein M is at least one Group IIIB, IVB, VB, or VIB metal,
wherein A is an A-group element,
each X is C, N, or a combination thereof, and
n=1, 2, 3, or 4 and;
removing substantially all of the intermetallic impurities from the MAX-phase composition,
thereby providing a composition comprising at least one layer having a first and second surface, each layer comprising a substantially two-dimensional array of crystal cells,
each crystal cell having an empirical formula of Mₙ₊₁Xₙ, such that each X is positioned within an octahedral array of M, and
wherein at least one of said surfaces of each layer has surface terminations comprising alkoxide, carboxylate, halide, hydroxide, hydride, oxide, sub-oxide, nitride, sub-nitride, sulfide, thiol, or a combination thereof.

13. The method of claim 12, wherein the A atoms are removed by a process comprising a treatment with a fluorine-containing acid.

14. The method of claim 13, wherein the fluorine-containing acid is aqueous hydrofluoric acid.

15. The method of claim 12, further comprising sonication.

16. The method of claim 12, wherein the MAX-phase composition comprises an excess of A, and optionally wherein the MAX-phase composition contains essentially stoichiometric amounts of M and X.

17. The method of claim 12, wherein removing substantially all of the A atoms from a MAX-phase composition is done electrochemically.
